(19) United States
(12) Patent Application Publication
(10) Pub. No.: US 2022/0156693 A1
(43) Pub. Date: May 19, 2022

(54) COMPUTERIZED SYSTEM AND METHOD FOR DEVELOPING OPTIMIZED CARGO TRANSPORTATION SOLUTIONS

(71) Applicant: Exel Inc. d/b/a DHL Supply Chain (USA), Westerville, OH (US)

(72) Inventors: Manjeet Singh, Columbus, OH (US); Yibo Dang, Columbus, OH (US); Gan Du, Columbus, OH (US); Bocheng Yu, Westerville, OH (US); Sigiang Guo, Westerville, OH (US); Paul Bugenstein, Westerville, OH (US); Jon Cox, Westerville, OH (US)

(21) Appl. No.: 16/950,538

(22) Filed: Nov. 17, 2020

(51) Int. Cl. G06Q 10/08; G06Q 10/04; G06Q 10/06; G06Q 30/02; G06N 7/00; G01C 21/34

(52) U.S. Cl. CPC G06Q 10/08355; G06Q 10/047; G06Q 10/06315; G06Q 30/0205; G06Q 10/08345; G01C 21/3453; G06Q 10/0838; G06Q 10/06312; G06Q 10/0637; G06N 7/005; G01C 21/3407; G06Q 30/0284

(57) ABSTRACT

A system and method for developing optimized cargo transportation solutions. The system may include a number of different modules (programs) that may be executed individually, or in series when an exemplary system includes the programs operating sequentially. Input to the programs may be obtained from the shipment files of an entity for whom a transportation solution is being created. The output of one program may act as at least a partial input to the next program when the programs are executed sequentially. One or more of the programs may employ optimization procedures such as ant colony optimization procedures and/or local improvement heuristics. The systems and methods are provided to determine a most cost effective shipping solution for given cargo.

### TECHNICAL FIELD

The general inventive concept is directed to systems and methods for the development, evaluation, and optimization of cargo transportation strategies.

### BACKGROUND

Transportation solutions are required by a myriad of companies across the globe relative to the delivery of cargo to warehouses, distribution centers, and/or other locations. These transportation solutions include, among other things, transportation design—the process whereby specific truck routes are created, specific cargo to be transported is allocated, and route completion schedules are determined.

Because of the large number of destinations to which typical carriers are required to deliver cargo and the thousands to millions of yearly shipments accomplished by a given carrier, it takes a significant amount of time for logistics professionals to develop optimal cargo transportation network solutions. The time required to develop these cargo transportation solutions is a bottleneck for the industry, incurs significant costs (typically from employee hours), slows enhancements of existing transportation network strategies, increases time required to pursue new business, and is far less than an optimal solution.

The current, known, process of developing cargo transportation solutions includes multiple mode selections with different programs and models supporting each stage. As would be well understood by one of skill in the art, the current process of developing transportation network solutions usually takes several weeks or even months, and requires analysts with specialized knowledge to repeatedly refine the mode selections. Currently available off-the-shelf third party commercial programs and software do not solve the complex problems required to optimize cargo transportation network solutions.

As should be apparent from the foregoing description, there is a significant unmet need for improved systems and methods for developing cargo transportation network solutions in less time and at a reduced cost. The systems and methods presented herein meet this need.

### SUMMARY

The exemplary systems and methods described herein are a significant improvement over known techniques for developing cargo transport solutions. Exemplary systems and methods analyze a full data set (without relying on sampling), access millions of potential solutions to determine an optimal result, and leverage data to create custom solutions tailored to specific owners or shippers of cargo to be transported (frequently referred to herein as “customers”). The use of exemplary systems and methods improve transportation design productivity, and provide for significant additional cost savings by increasing the rate of transportation fleet usage, decreasing other costs, minimizing empty backhauls, decreasing CO₂ emissions, and maximizing cross dock usage. Exemplary systems and methods are customizable, scalable across countries, inexpensive to implement, and include multiple reporting functions.

The exemplary optimized cargo transportation solution development systems and methods described in this application are operable to optimally assign trucks to specific routes, determine optimal truck routes, and minimize transportation costs. Exemplary cargo transportation solution issues addressed by the inventive concept include, without limitation, suboptimal freight and fleet decisions, pool point allocations, and empty backhaul trips.

Generally speaking, addressing suboptimal freight and fleet decisions according to the inventive concept means at least addressing the fact that known cargo transportation solutions are often designed utilizing subcontracted solutions and dedicated fleet solutions where a subset of shipments will be tendered to less than a truck load (LTL)/truck load (TL)/common carriers and the remainder of the shipments are contracted to a private fleet, based on cost and service. More specifically, exemplary systems and methods address deficiencies in the typical known transportation solution development process utilized by analysts, which can take as long as two weeks. In this known process, all of the cargo is routed within defined distance thresholds of TL<250 miles and TL<500 miles, the transactional common carrier cost is then compared to the allocated closed loop routing cost, one-way multi-stop routing opportunities from the shipments that are subcontracted to the common carriers are subsequently determined, and the remaining dedicated shipments are routed again.

While the above-described transportation solution design process is widely adopted in the third party logistics industry, underlying problems frequently result in sub-optimal solutions and low analyst productivity. Firstly, the distance thresholds are defined narrowly and, therefore, do not consider routing opportunities that exist outside of the pre-defined distance thresholds. Secondly, the current process does not optimize the cost between one-way, multi-stop routing and closed loop routing, which results in inefficient freight and fleet decisions that lead to higher costs, lost time, and higher carbon emissions. Thirdly, not all the routing constraints (e.g., time windows, multiple vehicle types, etc.) are considered in the current process. Moreover, according to known solution design processes, the shipment is rerouted several times using multiple commercial software solutions, and the data received from the rerouting procedure is analyzed by an analyst based on their experience. Therefore, the routing results emanating from the current transportation solution development process can be suboptimal and inefficient.

Exemplary systems and methods according to the inventive concept overcome the various aforementioned deficiencies in the current, known transportation solution development process that frequently result in suboptimal freight and fleet decisions. Exemplary systems and methods also eliminate the need for any significant post-routing analysis, thereby ensuring a higher quality solution at a lower cost.

Addressing the issue of pool point allocations according to the inventive concept means at least addressing the fact that shippers currently send LTL shipments directly to the final destination. To this end, the use of exemplary systems and methods described herein allows a shipper to instead consolidate shipments into a full TL sized shipment at the origin and to ship that cargo to a pool point closer to the final destination(s)—where the “origin” is defined as the original pickup point of cargo for delivery to another location and is typically located roughly in the center of a given region to serve customers within a radius of some predetermined number of miles (e.g., 150 miles), and where a “pool point” is defined as a cross-dock location that receives a consolidated TL sized shipment from a shipper and then organizes the shipment into individual LTL shipments to the final destination. Depending on the volume of shipments and other metrics in the analysis, the pool point selected may not be the closest to the final destination in some cases. The individual shipments received at the pool point are subsequently split and delivered by the LTL carrier to the final destinations (e.g., customers or other sites).

Consequently, users of exemplary systems and methods presented herein who also outsource to LTL providers, are able to more efficiently consolidate multiple LTL shipments into a line haul (the movement of freight between distant sites) to pool points, taking advantage of the very efficient loads of the LTL carriers. In contrast, shippers currently outsourcing to LTL providers must complete difficult solution design analyses in an effort to determine efficient pool points.

The type of current inefficient pool point allocation commonly used across the industry is illustrated in FIG. 1. Due to the simplicity of the illustrated transportation solution, only the LTL shipments within the circle might be assigned to the pool point in a consolidated TL line haul from the shipper. The other LTL shipments shown have to be shipped directly from the shipper to the destination even if it is more cost-efficient to use the pool point.

Addressing the issue of empty backhaul trips according to the inventive concept means addressing the fact that for most current TL shipments, a full truck sent to the designated destination(s) will make its scheduled deliveries and subsequently return to the origin (i.e., backhaul) empty. Under this traditional rule of operating TL line haul networks, a significant number of trucks will backhaul empty, resulting in significant wasted labor and transportation costs.

The problem of empty backhaul trips is simplistically represented in the diagram of FIG. 2, where there are shown four TL line hauls that would normally lead to four empty backhauls after the deliveries of the associated cargo to exemplary locations B, C, D and E. However, because location A and location D are in the same region and locations B and E are in the same region, making the delivery from location A to location B and then moving the empty truck the short distance to location E to use said truck to transport the cargo from location E to location D avoids an empty backhaul trip and also allows cargo to be delivered to locations B and D by a single carrier. A similar solution may be applied with respect to the initial delivery from location F to location E and the delivery from location B to location C.

Generally speaking, exemplary systems and methods according to the general inventive concept are modular in nature. For example, one exemplary system utilizes four modules for serially determining a customized, optimal cargo transportation solution based on the savings potential for a given carrier. The four exemplary modules are the (i) Freight Optimization (FrO) module; (ii) Fleet Optimization (FlO) module; (iii) Pool Point Optimization (PPO) module; and (iv) Round Trip Optimization (RTO) module.

Each module may operate on data from shipment files stored in the transportation systems of a given cargo owner or shipper, such as in a transportation management system or a data warehouse.

An exemplary cargo transportation solution development system can optimize large scale data sets that cannot be handled with existing software, third party tools or other traditional analytical methods. In an exemplary embodiment, the modules use shipment file data input information in the form of an input shipment file, freight optimization parameters, fleet optimization parameters, pool point optimization parameters, and round trip optimization parameters. The modules can be used sequentially or individually, based on the needs of a given project. Further, implementation of an exemplary cargo transportation solution development system does not require integration with existing system(s). An exemplary system can work as an external tool installed on user devices.

Other aspects and features of the inventive concept will become apparent to those skilled in the art upon review of the following detailed description of exemplary embodiments along with the accompanying drawing figures.

### BRIEF DESCRIPTION OF THE DRAWINGS

In the following descriptions of the drawings and exemplary embodiments, like reference numerals across the several views refer to identical or equivalent features, and:

FIG. 1 is illustrative of inefficient pool point allocation commonly associated with known techniques for cargo transportation solution development;

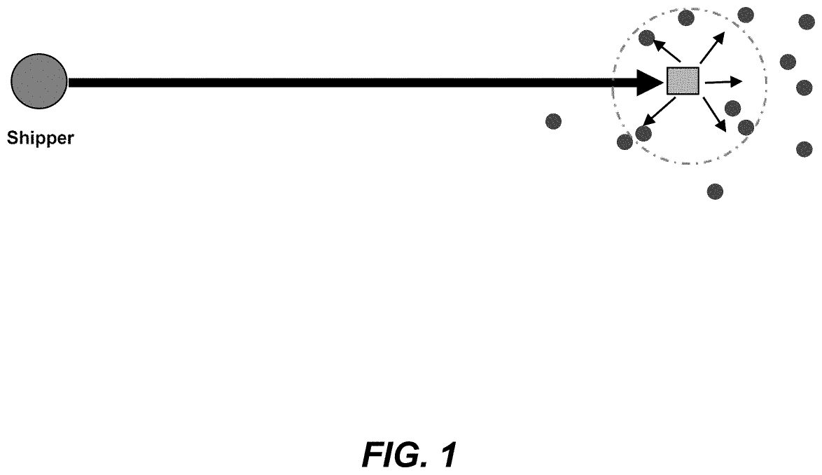

FIG. 2 simplistically represents the problem of empty truck backhaul trips;

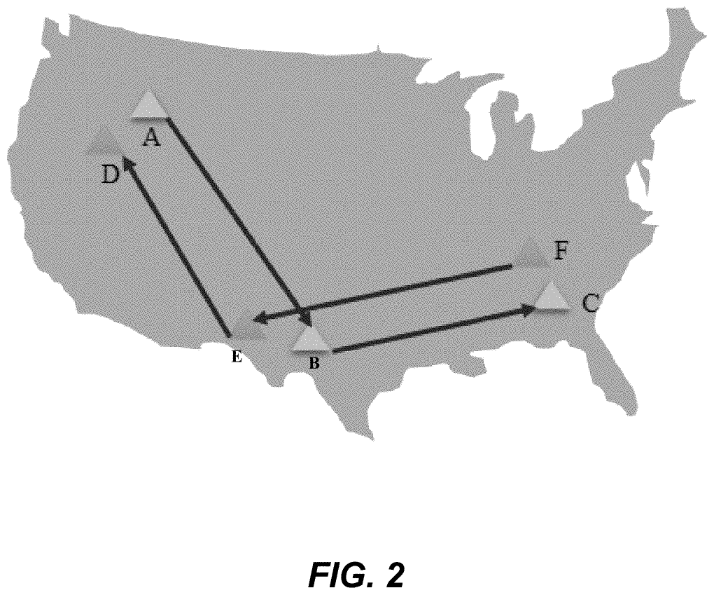

FIG. 3 represents the general functionality of an exemplary freight optimization program that may form a portion of an exemplary system for developing optimized cargo transportation solutions according to the inventive concept;

FIG. 4 graphically represents the operation of an exemplary ant colony optimization procedure;

FIGS. 5A-5B illustrate the effect of applying local improvement permutations and mutations to shipping route determinations made by an exemplary freight optimization program;

FIG. 6 represents the general functionality of an exemplary fleet optimization program that may form a portion of an exemplary system for developing optimized cargo transportation solutions according to the inventive concept;

FIGS. 7A-7B illustrate the effect of applying an exemplary optimization procedure to shipping route determinations made by an exemplary fleet optimization program;

FIG. 8 represents one exemplary local improvement permutation technique that may be utilized in conjunction with an exemplary fleet optimization program;

FIGS. 9A-9B provide a diagrammatic representation of applying an exemplary local improvement mutation procedure to shipping routes determined by an exemplary fleet optimization program;

FIG. 10 represents the general functionality of an exemplary pool point optimization program that may form a portion of an exemplary system for developing optimized cargo transportation solutions according to the inventive concept;

FIG. 11 is provided to illustrate the deficiencies associated with known processes for analyzing and determining the use of pool points in a cargo shipping process;

FIG. 12 represents the general functionality of an exemplary round trip optimization program that may form a portion of an exemplary system for developing optimized cargo transportation solutions according to the inventive concept;

FIG. 13 depicts an exemplary user interface for an exemplary computer system for implementing an exemplary system of developing optimized cargo transportation solutions according to the inventive concept; and

FIG. 14 depicts an exemplary user interface data input screen for an exemplary computer system for implementing an exemplary system of developing optimized cargo transportation solutions according to the inventive concept.

### DETAILED DESCRIPTION OF THE EXEMPLARY EMBODIMENTS

As summarized above, systems and methods according to the application are directed to developing optimized cargo transportation solutions that are customized to the needs of individual owners or shippers of cargo to be transported (i.e., “customers”). The solutions are developed using large-scale (e.g., annual) customer shipment data to, for example, optimally assign trucks to specific routes, determine optimal truck routes, and minimize transportation costs.

The inventive concept described herein is implemented in the form of one or more computer applications operating on a computer. Both a system and method for developing optimized cargo transportation solutions may be provided.

A system for developing optimized cargo transportation solutions may include at least one hardware processor operable to receive and process a cargo transportation solution development request. An exemplary hardware processor may be embodied in one or more computers. In an exemplary embodiment, a system may take advantage of the power of parallel computing using multiple processors.

Based on the associated data input to the at least one hardware processor, the at least one hardware processor may be further operable to execute a freight/fleet optimization program that may at least determine optimized one-way multi-stop routing, determine optimized closed-loop routing, and determine and report associated costs.

Relative to the optimized one-way multi-stop routing and/or the optimized closed-loop routing determination operations, the at least one hardware processor may be further operable to employ ant colony optimization techniques, to compare costs between one-way multi-stop routes and/or closed-loop routes with direct LTL routes.

Subsequent and responsive to executing the freight/fleet optimization program, the at least one hardware processor may be further operable to execute a pool point optimization program that receives direct LTL shipment input data from the freight/fleet optimization program and considers factors such as TL and LTL tariffs, the availability of pool cities, and truck capacities and baseline charges, to perform an iterative pool point optimization operation that outputs optimized pool decisions and decomposed costs.

Subsequent and responsive to executing the pool point optimization program, the at least one hardware processor may be further operable to execute a continuous move optimization program that receives direct LTL/TL shipment input data from the pool point optimization program and considers factors such as cost parameters, waiting time constraints, empty miles thresholds and the allowed number of stops, to determine the optimal transportation solutions, such as by using iterative clustering and heuristic techniques.

The at least one hardware processor may be further operable to output the results of the optimizing operations that may include but is not limited to, optimized routing details, associated cost savings, and a shipping schedule.

A method for developing optimized cargo transportation solutions may include receiving a cargo transportation solution development request. In response to said request, the method may comprise inputting shipment file data of the requester and subsequently executing a freight/fleet optimization program that may result in at least determining optimized one-way multi-stop routing, determining optimized closed-loop routing, and determining and reporting associated costs, such as by employing ant colony optimization techniques, and comparing costs between one-way multi-stop routes and/or closed-loop routes with direct LTL routes.

An exemplary method may also include, subsequent and responsive to executing the freight/fleet optimization program, executing a pool point optimization program that receives direct LTL shipment input data from the freight/fleet optimization program, considers factors such as TL and LTL tariffs, the availability of pool cities, and truck capacities and baseline charges, and performs an iterative pool point optimization operation that determines and outputs optimized pool decisions and decomposed costs.

An exemplary method may further include, subsequent and responsive to determining optimized pool decisions and decomposed costs, executing a continuous move optimization program that receives direct LTL/TL shipment input data from the pool point optimization program, considers factors such as cost parameters, waiting time constraints, empty miles thresholds and the allowed number of stops, and determines the optimal cargo transportation solutions.

An exemplary method may also include outputting the optimal transportation solutions, such as by providing without limitation, optimized routing details, associated cost savings, and an optimized shipping schedule.

A computer readable storage medium storing machine-readable instructions executable by a machine to perform one or more methods described herein may also be provided.

One exemplary system according to the inventive concept comprises four modules. The modules may be used individually, but may also be used serially to determine a customized and optimal cargo transportation solution for a given shipper. In this example, the four modules are (i) a freight optimization (FrO) module; (ii) a fleet optimization (FlO) module; (iii) a pool point optimization (PPO) module; and (iv) a round trip optimization (RTO) module. Each module is embodied as a computer application (program) that operates on a computer and utilizes shipping data—typically, data from the shipment files of a given owner or shipper of the cargo to be transported.

Freight Optimization (FrO)

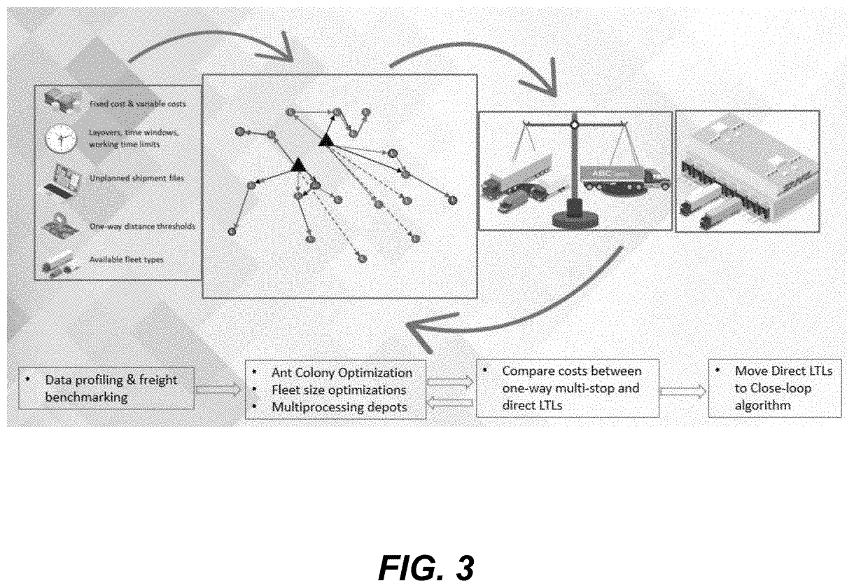

The FrO module is the first of the four modules in the exemplary optimized cargo transportation solution development system. The FrO module is implemented as a computer program designed to run on a computer. The functionality of an exemplary FrO program is graphically illustrated in FIG. 3.

The FrO program preferably receives as input, the full input shipment file of a given customer for whom an optimized cargo transportation solution is being developed. An exemplary input shipment file will typically include parameters such as, for example: distinct shipment ID; week; origin location—origin city, state, zip-code, latitude, longitude; destination location—destination city, state, zip-code, latitude, longitude; shipment units; shipment weights; shipment volumes; origin destination miles; shipping date and delivery date; shipment class; original transportation mode; rated common carrier cost; and information as to whether or not the shipment is required to be routed on a dedicated fleet.

An exemplary FrO program may consider parameters such as, but not limited to, maximum number of stops; maximum number of layovers; maximum driving and working hours per day; minimum unloading time (hour); maximum allowed distance between stops; weight and volume capacities of the freight; average speed of the freight (mph); cost charged for a stop on the one-way multi-stop route; delivery time window; unloading speed (unit/hour); route interval—minimum and maximum distance to origin; and zip-code to zip-code unit rate matrix ($/mile) charged by the shipper.

The FrO program is designed to minimize shipping cost by comparing the cost of one-way multi-stop routes and the direct LTL shipping costs from common carriers. Absent the use of the FrO program, the cost of transporting the shipments of interest would simply be the summation of the direct LTL shipping costs.

The FrO program is operable to search for a transportation path that links shipments together and transports the associated cargo on the same truck (known as a feasible path). The criteria for a feasible path is that with all the shipments consolidated in the same truck, the feasible path must be in accordance with the constraints input by the user. Such constraints may include, for example and without limitation, a delivery time window, truck capacities, distance thresholds, layovers, etc. The objective of the FrO program is to find the most cost-efficient one-way multi-stop routes that delivers all the shipments in accordance with the constraints.

The FrO program also operates to determine which shipping routes are not sufficiently cost-efficient to be operated by shippers. The FrO program begins operation by comparing the one-way multi-stop route cost with the associated direct LTL cost. If the FrO program determines that using any of the one-way routes it creates would be more costly than using direct LTL shipping, those created routes will be unrouted and divided into single shipments. The cost comparison will run repeatedly along with the route search iteration until the FrO program reaches a near-optimal solution. The direct LTL shipments remaining after FrO program operation will be passed to one or more of the other program modules (e.g., the FlO module) for further optimization in the case where multiple modules are present and used sequentially.

The FrO program may be metaheuristic in nature, whereby the program will operate to find the optimal transportation solutions that are a combination of subcontracted solutions and one-way multi-stop solutions. That is, the FrO program is operable to evaluate when a subset of shipments will be tendered to direct LTL carriers and the remainder of the shipments are contracted to freight carriers based on cost and services.

The FrO program may operate based on two primary inputs: standard input shipment files and freight optimization parameters. The freight optimization parameters may include, without limitation, time constraints, capacity constraints, basic cost parameters, the tariff used to rate the zip-to-zip travel cost, and/or any of the other parameters identified above.

In an exemplary embodiment, the FrO program may employ an ant colony optimization procedure to simultaneously optimize the routing and cost comparisons. The output of FrO program includes a detailed transportation route from an identified origin to an identified destination. The detailed transportation route includes the associated route cost, sequence of the shipments on the route, actual delivery time, and the optimized cost for delivering each shipment.

The logic of the exemplary FrO program is such that the entire shipment file will first be preprocessed by grouping shipments by distribution centers and by ship dates. The program is then multi-processed over each sub-group. The ant colony optimization functionality of the program may subsequently run specific iterations for each sub-group of the shipments to determine which shipments should be routed by freight and which shipments should be considered as direct LTL shipments, which may be further optimized by other system modules in a sequential module embodiment.

More specifically, for each iteration, the exemplary FrO program initially assumes that all the shipments can be routed via the created one-way routes, and then employs the ant colony optimization functionality to determine the feasible routes that cover all of the shipments. Next, for each determined feasible route, a local improvement heuristic procedure referred to as permutation is executed to reorder the sequence of that route to reduce the cost of the created one-way route. Another local improvement heuristic procedure referred to as mutation is then executed to exchange the nodes on two neighboring routes in order to find two new routes that reduce the total cost. Finally, for each created one-way route, the FrO program compares the associated freight cost with the associated direct LTL shipping cost and the potential fleet cost. If the freight cost is lower than the other two costs, the FrO program keeps the route in the solution. If the freight cost is higher than the direct LTL shipping cost and/or the potential fleet cost, then the one-way route is deemed to be not cost-efficient, and the user can select shipment delivery by fleet and/or direct LTL carrier at a lower cost.

From the foregoing explanation, it should be understood by one of skill in the art that, according to operation of the exemplary FrO program, a created one-way route is divided into individual shipments and the cost of the shipments is updated by the associated direct LTL shipping cost, and that the exemplary FrO program generates multiple solutions in each iteration in order to pick the solution with the lowest cost and to move to the next iteration. Further, the FrO program preferably repeats the aforementioned procedures iteratively for some pre-specified number of iterations before the lowest cost solution is finally output in the form of the best route assignments for the shipments. Once operation of the FrO program is completed, the remaining unrouted direct LTL shipments may be input to other system modules in embodiments where the system includes multiple program modules operating sequentially.

Additional details regarding exemplary FrO program functionality/operation are provided below, with the various parameters/variables used by the exemplary FrO program first summarized in the following Table 1.

TABLE 1
Parameters used by the FrO (and FlO) program

| | | Descriptions |
|---|---|---|
| parameters | I | {0, 1, . . . , n} Set of customers in the dataset, |
| | | where 0 denotes the depot or the warehouse. |
| | A | Set of arcs that connect customers. |
| | V | Set of available trucks |
| | wᵢ | A positive demand associated to customer i ∈ I |
| | ηᵢⱼ | Visibility or attractiveness of node j to the |
| | | current node i |
| | τᵢⱼ | the pheromone concentration on edge (i, j) |
| | mᵢ | The direct LTL cost for shipment i quoted from |
| | | the common carrier tariff |
| | q₀ | Threshold parameter that is greater than 0 and |
| | | less than 1 |
| | ĵ | The selected next customer j avoiding the tabu |
| | | list |
| | dᵢⱼ | Distance from node i to node j |
| | α, β, ρ | Ant colony search related parameters |
| | L_{global} | Current iteration best objective function value |
| | τ₀ | Initial pheromone value, which is the inverse of |
| | | the total distance of the complete graph |
| | q₀ₛ | the value of q₀ at step s in the route |
| | z(sₖ) | Cost of route s while it is operated by truck k |
| | cᵢⱼₖ | Mileage cost of traveling from node i to node j |
| | | by truck k |
| | N | Prespecified iteration numbers |
| | Cᵢ | Cost of shipping node i after running the |
| | | algorithm |
| | C_{K} | Cost of shipping route K after running the |
| | | algorithm |
| | Rₖ^{l} | Local improvement heuristic invoked probability |
| | | for solution l in iteration k |

As would be understood by one of skill in the art, ant colony optimization (ACO) is a metaheuristic technique that uses virtual ants to find solutions for large combinatorial optimization routing problems by mimicking the navigation of natural ants. ACO contains elements of both genetic algorithms and taboo searches.

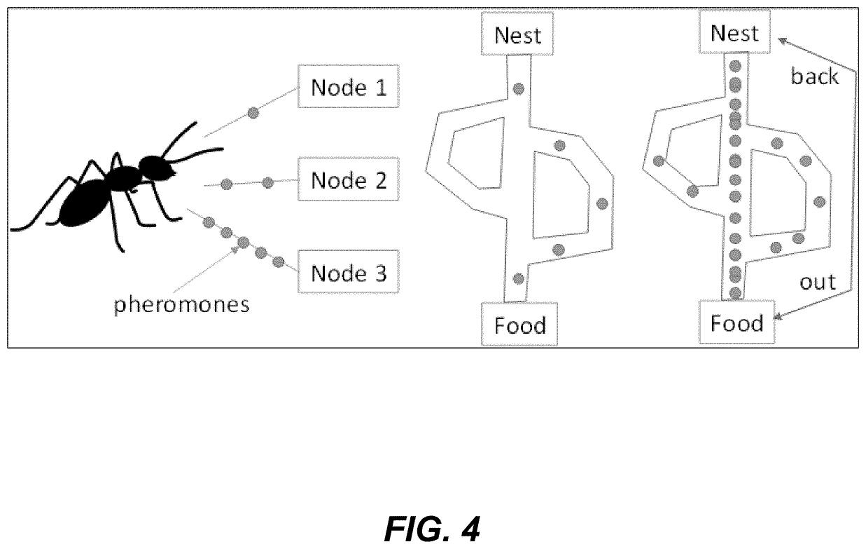

As represented in FIG. 4, while searching for food, ants communicate with their colonies using a chemical essence referred to as a pheromone. As an ant travels, it deposits pheromones at a relative constant rate and volume. Initially, ants will choose paths in a random manner, but when they encounter a trail with pheromones already present, ants will be attracted by that trail and lay down their own pheromones along the way so that the trail is reinforced. Finally, as pheromone accumulates on a given path, the probability of the next sets of ants selecting that path will be increased. In addition, if an ant reaches a food source with a short route, it will return to its nest earlier and thus its pheromone marks the route twice before other ants return. As time passes, and pheromone accumulates, longer routes towards food sources are less likely to be detected by the next ants. Also, since the search process is a probabilistic-based random selection, alternative solutions will occur consistently until optimal paths are collected.

With respect to optimizing cargo transportation solution development using ACO, each ant may be equated with a fleet of trucks. When the ant (trucks) initially leaves the nest (origin) it represents a single one of the trucks. When the ant returns and then leaves the origin again, the ant represents a new truck. The scope of the ant ends whenever either all packages are delivered or all truck capacity is filled. In the searching process associated with the FrO program, if a previous truck in the ant colony (truck fleet) has already delivered a package, or the desired location cannot be reached, the node is stored in an infeasible or tabu list. As indicated below, the exemplary FrO program uses the notation Tabu^{k} to store nodes that have already been visited by ant (truck) k and nodes that violate constraints so that they are removed from further consideration.

The core of the ant colony step applied in vehicle routing is generally a vehicle step from one node to another. In this regard, assume that an ant is considering moving from node i to node j. As part of the process, the ant “decides” either to explore or to exploit with a probability matric influenced by pheromones from previous ant colonies. In the case of the FrO program, τᵢⱼ represents the pheromone concentration on edge (i, j), which is equal to the amount of pheromone on the path between the current node i and possible nodes j from candidate lists. Further, the “visibility” value ηᵢⱼ on edge (i, j) used by the FrO program is defined as the inverse of the distance (dᵢⱼ) between two nodes of interest (e.g., customer nodes) as: ηᵢⱼ=dᵢⱼ⁻¹. The distribution is thus described by the FrO program with uniformly distributed q and threshold parameter, q₀ as follows:

$$\hat{J} = \{ \begin{matrix}{arg max}_{j ∉ {Tabu}^{k}} \{ {( {τ}_{ij} )}^{α} {( {η}_{ij} )}^{β} \} & if q \leq {q}_{0} ( exploitation ) \\ random j ∉ {Tabu}^{k} & otherwise ( exploration )\end{matrix} \qquad ( 1 )$$

where ĵ is the selected next customer j avoiding the tabu list.

In standard formulations, the “visibility” parameter β controls the importance of distance in comparison to pheromone quantity. Each time at node i, the ant will select arc j with highest exploitation unless the value of q from a random draw is greater than q₀. If q>q₀, the ant starts exploration. Then, the chance of moving from node i to j for ant k is:

$${p}_{ij}^{k} = \{ \begin{matrix}\frac{{( {τ}_{ij} )}^{α} {( {η}_{ij} )}^{β}}{{{Σ}_{l ∉ {Tabu}^{k}} ( {τ}_{ij} )}^{α} {( {η}_{ij} )}^{β}} & if j ∉ {Tabu}^{k} \\ 0 & \text{otherwise}\end{matrix} \qquad ( 2 )$$

Intuitively, exploitation adopts the experience gained by former ants (pheromone updating) using updating as described below. Yet, exploration is also vital, because this behavior allows exploring new, possibly better tours in the neighborhood.

To improve future solutions, pheromones on the trail can be updated each time an ant travels over it (locally) and after each set of n ants or colony travels over it (globally). After individual solutions are generated, local updating is preferably conducted by the FrO program on the visited arcs to reduce the accumulated pheromone volume so that no arc becomes so dominant that it impedes or prevents the exploring of new edges. The local updating may be represented as:

τᵢⱼ=ρ·τᵢⱼ+(1−ρ)·τ₀(local)

where 0<ρ<1 is an “evaporation” parameter, which controls the tradeoff between fresh-laid pheromone τᵢⱼ and the initial pheromone value τ₀. Adopting the inverse of the best-known total distance could lead to a better convergence rate.

Next, a global updating rule is derived after all n solutions are evaluated and the current iteration best, L_{global} is identified. An exemplary global updating rule may be represented as:

$${τ}_{ij} = ρ \cdot {τ}_{ij} + ρ \cdot {Δ}_{ij} , \\ where {Δ}_{ij} = \{ \begin{matrix}\frac{1}{{d}_{ij}} , & if arc ( i , j ) belongs to {L}_{global} \\ 0 , & \text{otherwise}\end{matrix} ( global ) \qquad ( 3 )$$

where dᵢⱼ is the distance between node i and j.

This global updating rule tends to assign shorter arcs with higher pheromones, if the arcs are on the global best route. Thus, the probability to choose those arcs will be increased in future iterations. However, if an arc is not included in the best solution, the ρ evaporation factor helps to reduce the pheromone on that arc.

Another common element of ant colony searches is the evolution of model parameters within the construction of each ant. During initialization, the hyper parameters (α, q₀, φ are assigned as 1. Then, for the following iterations, the FrO program has two parameter series. Firstly, the settings of α=1, ρ=0.9, q₀=0.9, and β=2.3 are regarded as robust. Secondly, the FrO program adopts an adjusting rule, which is inspired by inexact line search, for q₀ and ρ, and which may be represented as:

$${q}_{0 s} = \{ \begin{matrix}0.9 {q}_{0 ( s - 1 )} , & if 0.9 {q}_{0 ( s - 1 )} \geq 0.65 \\ 0.65 , & \text{otherwise}\end{matrix} \\ {ρ}_{s} = \{ \begin{matrix}0.9 {ρ}_{s - 1} , & if 0.9 {ρ}_{s - 1} \geq 0.65 \\ 0.65 , & \text{otherwise}\end{matrix}$$

If the chance of selecting the arc is too low (the value of q₀ is too large), the FrO program may reduce the parameter value by 0.9, so that there is a better chance to undertake exploration. However, the FrO program may also use a lower bound of 0.65 to limit the chance of exploration and assure quality routes are maintained. As used here, q₀ₛ denotes the value of q₀ at step s in the route. This adjustment tends to encourage explorations for nodes at a route tail.

It is not feasible for some nodes to be connected (e.g., nodes are too far apart). Performing a preprocessing operation to generate “candidate lists” (Λ(i)) for each node may be undertaken by the FrO program to increase the computational performance. For example, with respect to node i, only nodes having an earliest arrival time that is before the latest arrival time of node i may be checked. However, because this preprocessing operation is time consuming and overlapped with a feasibility check, an alternative method is to sort the input shipments by their 5-digit zip codes and latest delivery date, then consider the nodes in the neighborhood(s) of node i.

As mentioned above, the FrO program may include local search functionality to enhance its performance. That is, when each ant finishes its route during the ant colony optimization procedure, a local search heuristic referred to as permutation may be applied to improve the sequence of the route. Further, when all ant colonies have computed network plans within a single optimization iteration, another local heuristic function referred to as mutation may be executed to improve the solutions obtained by each ant colony.

An exemplary permutation procedure associated with an exemplary FrO program is represented below.

FrO Program - Permutation procedure (Algorithm 1)
DP procedure to find the cheapest cost from depot (0) to node (j)

```
Input:
Current route sequence (0, i₁, i₂, ... , i), V(i₁, ... , iₙ, i), c(0, ... , i, 0, ... , i), Fn(i₁, ... , i) = −1;
Next(0, i₁, i₂, ... , i) = −1, z(sₖ), out − degree(0, i₁, i₂, ... , 0) = 0;
* define the recursive function f (x) to calculate route cost Fₙ *
c(i, j) = cᵢⱼₖ;
f(i) = mi n{c(i, j) + f(j): (i, j) ∈ sₖ}, if i ≠ 0 and out − degree ≠ 0;
Boundary condition:
$f ( i ) = \{ \begin{matrix}0 , & if x = length of route {s}_{k} , where x is the number of stage \\ ∞ , & if i \neq 0 and out - degree ( 0 , … , i ) = 0\end{matrix} ;$
Function f (x, i)
* while ith stage on this route has not been filled *
if Fᵢ(x) = −1 then
  if x = 0 and i = n + 1 then
    Fᵢ(x) ← 0;
  else if x ≠ 0 and i = n + 1 then
    Fᵢ(x) ← ∞;
  else if out − degree(0, ... , x) = 0 then
    Fᵢ(x) ← ∞;
  else
    Fᵢ(x) ← min{c(i, j) + f(y, i + 1): (x, y) ∈ sₖ, y ∈ V (x)};
    if Fᵢ(x) ≥ z(sₖ) then
      Fᵢ(x) ← ∞;
    else
      Next(x) ← node y which yielded the min;
    end
  end
  return Fᵢ(x)
end
Output: z(sk) ← min{f(0,0), z(sₖ)}; (0, i₁′, ... , iₙ′, i).
```

An exemplary mutation procedure associated with an exemplary FrO program is represented below.

FrO Program — Mutation heuristic (Algorithm 2)

```
Result: improved cost z (A) of n routes
Input:
  n route sequences from the current sub-optimal solution with a cost of z^{H} (A);
Step 1:
  Select the kth ant and the (k+i)th ant from the current solution, where i ≤ min{n, n₀},
where n₀ is the upper bound of the considered nearby routes for kth ant Try to exchange
the nodes on the paired routes. If one route is too short (e.g. with 1 node), try merge the
two routes;
Step 2:
  Exchange the nodes on the paired routes, generate child solutions and check the
feasibility and the updated cost If the updated routes k′ and (k′ + i)′ are feasible and the
cost z^{H} (A) decreases, this mutation is accepted, otherwise, reject it and move to the next
change;
Step 3:
  i ← i + 1, go to Step 1 and repeat; if i = min{n, n₀}, let k ← k + 1, go to step 1 and
repeat.
```

In the FrO program (and the FlO program described below), there are usually many possible solution options at the beginning of a program run. The number of solution options decreases and the solutions become more efficient after each iteration performed by the FrO program. Therefore, conducting the local permutation and mutation heuristic operations for every ant and every solution may waste computation power, and the local permutation and mutation heuristics are instead preferably (but not necessarily) applied on each iteration probabilistically. In this regard, the mutation and permutation probability at the iteration k is defined as:

$${R}_{k}^{l} = \frac{1}{\vert I \vert} + {( \frac{1}{{n}_{k}^{l}} - \frac{1}{\vert I \vert} )}^{1 - \frac{k}{N}} \qquad ( 6 )$$

where |I| is the total number of customers, nₖ^{l} denotes the number of routes (ants) in the lth solution of the kth iteration, and the total iteration numbers are set as N. This calculation leads to more local searches in later iterations and in solutions with high ratios of route numbers to customer numbers.

When the FrO program applies the local search improvement heuristics, each node is evaluated through an interchange process, which compares the selected route to a different route on the candidate list. An interchange, or change in route, will be accepted only if all the constraints are satisfied and the cost of the selected route decreases. Next, every node i (besides origins) will be permutated with its descendant i+1 to check if constraints are satisfied and cost is reduced.

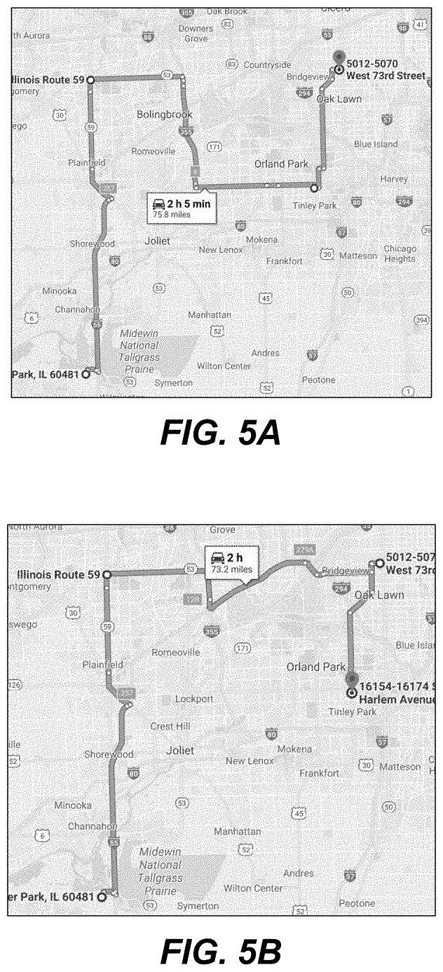

One exemplary output of the FrO program is illustrated in FIGS. 5A-5B. FIG. 5A represents a shipping route determination made without applying the interchangeable permutations and mutations, while FIG. 5B represents a shipping route determination made for the same shipment but with the interchangeable permutations and mutations applied. In this particular example, permutation of the last two nodes results in a route distance that is decreased from 75.8 miles to 73.2 miles.

Exemplary embodiments of the FrO program may also employ a one-way ant colony optimization technique, which attempts to find feasible one-way routes and to improve said routes by repeatedly running one-way routes until reaching a near-optimal solution. An exemplary one-way ant colony optimization technique may be represented as follows:

```
  Initialization: Initialize same amount of pheromone (π) on all combinations of
  edges
  For iteration [symbol]    1 to number of iterations
    For ant [symbol]    1 to number of ants
        Set the parameters α = β = 1.
      {Construct the route for each ant starting the first truck at the depot
    $Stopping Criteria = \{ \begin{matrix}No other package can be delivered ( all capacity \\ is used or all packages are delivered ) .\end{matrix} \}$
        Repeat
        {At each node i not visited, pick next move by
        Equation (1) and (2) using candidate lists.
          If (Hit truck capacity, i.e., 100%) or (Hit time and layover
constraints) Then
            One route is completed and the ant starts another one-way route.
            Call the local updating rule in Equation (3).
          End if
        Update the hyper parameters, e.g., using Equation (5).
          End Repeat
        } Next ant
If {Local Search is to be used based on Equation (6)} Then Perform Search End If
  Evaluate all solutions and store the best.
  Call global updating rule, π is prepared for the next colony in Equation (4).
  Update the overall best solution.} Next iteration
```

As discussed above, the exemplary FrO program operates, at least in part, to compare created one-way multi-stop route costs with associated direct LTL shipping costs and to determine whether to employ one-way multi-stop shipping or direct LTL shipping for a given cargo shipment. One exemplary embodiment of one-way route versus direct LTL shipping decision-making functionality of an exemplary FrO program is represented below.

Call ACO Algorithm

| For k←1 to (Number of routes or trucks ) | |
|---|---|
| { Call Cost Comparison and Make-Buy /*Decompose Cₖ by nodes*/ | |
| /*nk is the number of shipments on that route*/ | |
| If Cₖ ≥ Σᵢ₌₁ mᵢ then | |
| i. | Shift all nodes from the one-way routes to common carrier list that |
| | may decrease the total cost, let the final route cost be LocalBest |
| ii. | For each node remained on route, calculate the cost TempCost of |
| | shifting it to common carrier list |
| iii. | Determine the difference e = TempCost − LocalBest |
| iv. | If e < 0, then the shift is accepted; otherwise, the shift will be |
| | accepted with probability e. The greater e is, the less possible will |
| | we make the shift |
| v. | Repeat until all nodes on route k have been evaluated. |

End If }
Output all the routes and their costs.

As also discussed above, the FrO program is operable to determine and output the lowest cost cargo transportation solution in the form of the best route assignments for the shipments of interest. To that end, the FrO program calculates the optimized cost for delivering each shipment according to the following rule:

```
Suppose route A is the route to be considered, then:
    if A is a one way multistop route:
                                  if A is the last stop on route A:
```

| | |
|---|---|
| ${C}_{i} = \frac{1}{2} \cdot \frac{{w}_{i}}{{w}_{A}} \cdot [ {C}_{A} - ( \vert A \vert - 1 ) \cdot p ] + \frac{1}{2} \cdot \frac{{d}_{0 i}}{{d}_{0 A}} \cdot [ {C}_{A} - ( \vert A \vert - 1 ) \cdot p ]$ | (7) |
| else: | |
| ${C}_{i} = \frac{1}{2} \cdot \frac{{w}_{i}}{{w}_{A}} \cdot [ {C}_{A} - ( \vert A \vert - 1 ) \cdot p ] + \frac{1}{2} \cdot \frac{{d}_{0 i}}{{d}_{0 A}} \cdot [ {C}_{A} - ( \vert A \vert - 1 ) \cdot p ] + p$ | (8) |
| else: | |
| Cᵢ = mᵢ | |

This means, if route A is assigned to a carrier, the cost for each shipment i on this route is calculated by Equations (7) and (8), depending on whether or not i is the last stop on route A. However, if it is not cost-efficient to ship route A using a carrier, each shipment i on this route is assigned to a direct LTL shipper with the initial common carrier cost mᵢ.

Fleet Optimization (FlO)

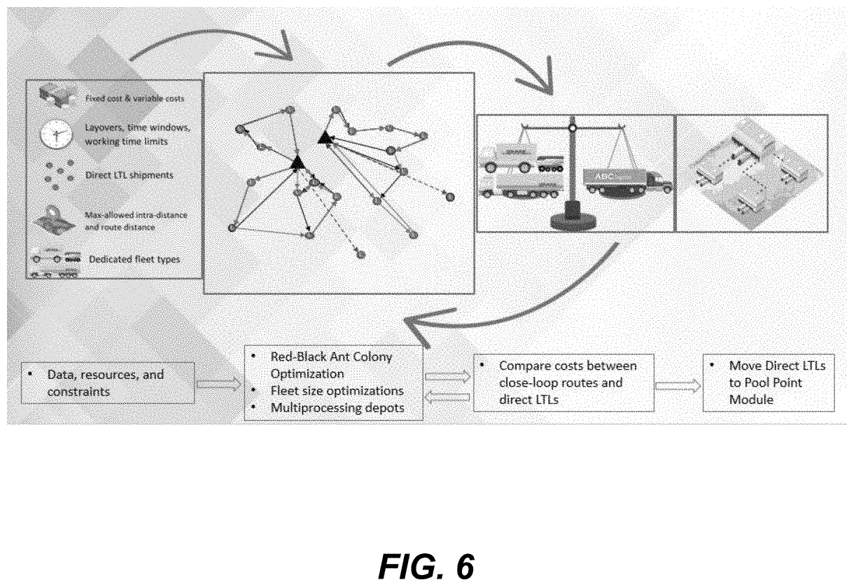

The fleet optimization (FlO) module is another possible module of an exemplary system for developing optimized cargo transportation solutions, and is also the second module in the series of modules when an exemplary system utilizes multiple modules operating sequentially. The FlO module is implemented as a computer program designed to run on a computer. The functionality of an exemplary FlO program is graphically illustrated in FIG. 6.

An exemplary FlO program may consider parameters such as, but without limitation, maximum number of layovers; maximum driving and working hours per day; minimum unloading time (hour); unloading speed (unit/hour); maximum allowed distance between stops; maximum allowed distance for a closed loop route; cost charged for each stop on the closed loop route; delivery time window; and different fleet types with their capacities, speed, and costs.

The FlO program is operable to calculate the near-optimal routing of direct LTL shipments with a dedicated fleet, where a dedicated fleet is a group of trucks that is solely responsible for all of the cargo transportation needs of a particular owner or shipper of products to be transported. The objective of the FlO module is to minimize the transportation cost over two shipping modes—fleet and direct LTL.

This problem is encountered by many third party logistics companies and is normally solved by a manual process performed by skilled analysts. The current, manual, process has two steps—(a) closed loop routing and (b) cost estimation. A closed loop routing analysis is performed using a combination of commercial routing software and the experience of the analyst or internal company expertise and knowledge. Cost estimation is performed on the basis of routes generated by the closed loop routing analysis, and the overall cost of all deliveries for the two (fleet and direct LTL) transportation modes is manually estimated and used in the solution design decisions made by the analyst.

It is difficult according to the known, manual, process to ensure that all practical routing and customer constraints are satisfied without sacrificing the solution quality. Due to the complexity and breadth of the calculations required to determine whether to utilize dedicated fleet or direct LTL shipping, even current off-the-shelf optimization tools are not a viable solution.

An exemplary FlO program according to the inventive concept preferably solves the two step process of closed loop routing and cost estimation simultaneously using a metaheuristic technique. Testing of exemplary FlO program embodiments indicates that the FlO program can reduce the current costs associated with use of the current solution design process by more than 15%.

The FlO program considers detailed operational constraints, observes strict time windows, and is designed to make efficient outsourcing decisions that optimize cargo transportation costs. Because it may take several days to complete certain long-haul routes, the FlO program may also consider the working hour restrictions and rest intervals of the transportation company employees.

At least some shippers manage heterogeneous vehicle types, which means different costs, capacities, and speeds. Also, different cargo may be consolidated into one truck, meaning that unloading time differs for each single delivery. For example, a shipment of tires may require one hour to be unloaded, while the same volume of electronics requires more time.

To solve the complicated problems associated with minimizing the transportation cost over both fleet and direct LTL shipping modes, the FlO program may employ a metaheuristic procedure called Red-Black Ant Colony System (RB-ACS), which is a system that would be generally familiar to one of skill in the art. In the case of applying RB-ACS to cargo transportation solution development, the colors represent the modes of shipment—the black ants associated with the use of fleets to perform closed loop routing, and the red ants associated with the shipments that should be shipped by direct LTL method.

The proposed RB-ACS approach relative to FlO program operation is a probabilistic search procedure that uses cooperative agents (ants) to build feasible solutions. On each iteration (for all agents), the desirability to serve a feasible customer i may be evaluated by the “greedy rule”. The greedy rule assumes that an ant is considering moving from node i to node j. Then, the ant “decides” either to explore or to exploit with a probability metric influenced by pheromones from previous ant colonies. RB-ACS has two pheromone trails to manage the knowledge of agents: red ants and black ants. The former is updated within the group of potential direct LTL shipments, in order to find any cost-efficient routes that can be operated by the dedicated fleet. The latter is updated within the group of shipments that have already been searched for cheaper dedicated fleet opportunities in the past iterations.

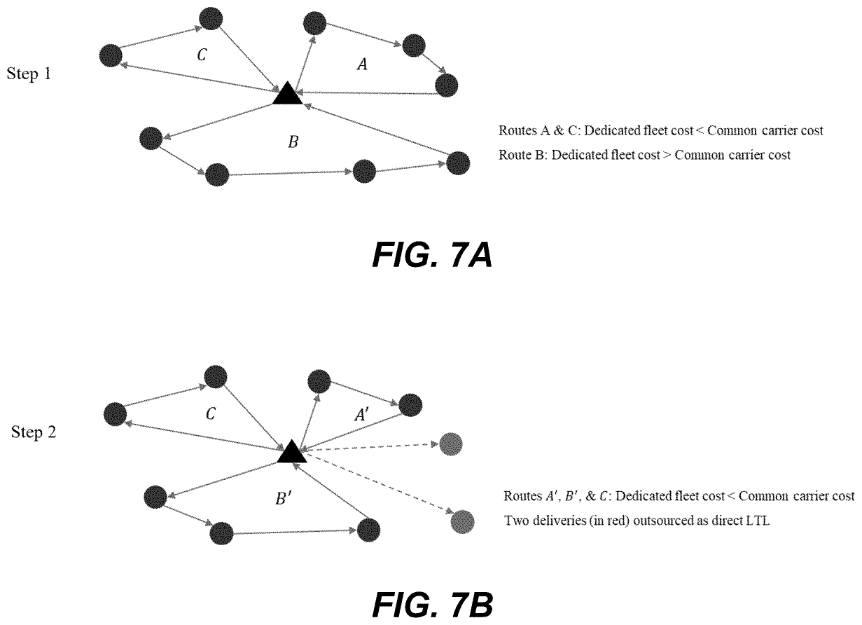

A simple example of the mode decisions made during each iteration of FlO program execution is illustrated in FIGS. 7A-7B. First, the dedicated fleet cost is calculated and compared with the associated common carrier cost for the three routes (A, B, C) indicated in FIG. 7A. Next, if certain shipments/routes are determined to be not cost-efficient using the dedicated fleet, said shipments/routes will be removed and outsourced to common carriers. In the example of FIG. 7A, operating route B with a dedicated fleet is more expensive than operating route B with a common carrier. Consequently, the RB-ACS procedure of the FlO program uses local heuristics to determine the two direct LTL shipments (red nodes) that can be outsourced to a common carrier to provide an improved solution, which is represented as routes A′, B′, C in FIG. 7B.

As with the FrO program, the FlO program can be used either independently or sequentially. If a user wants to find only closed loop routing opportunities, the FlO module can be executed with the whole input shipment file, assuming initially that all the shipments are outsourced as direct LTL shipments. On the other hand, if the FlO program is run sequentially, such as but not limited to subsequent to the FrO program, the FlO program will receive the unrouted shipments from the FrO program as its input shipment file.

The RB-ACS functionality within the FlO program is an iterative heuristic procedure. The RB-ACS may consist of four portions: (a) Red and black transition rules; (b) local heuristic improvements; (c) fleet type optimization; and (d) iterative runs over different fleet types.

When finding feasible routes in (a), the RB-ACS assumes the first node i on a dedicated fleet route is served at its earliest acceptable delivery time. To make sure each move of the truck is to a feasible node j, the RB-ACS checks the remaining truck capacity, whether the time window of j can be satisfied, whether the intra-node distance is violated, and if the driver needs to have a layover before the delivery. Moreover, the number of layovers and the total route distance (which includes the travel distance back to the depot) should be traced so that neither of the two constraints are violated.

As noted previously, the basic procedure of an ant colony search is to use virtual ants to find solutions for large combinatorial optimization routing problems mimicking the navigation of natural ants. To decide which customers should be routed on a fleet truck, red and black transition rules are defined. Suppose at a given step, k out of the n customers may be feasibly added to the truck. Then, the ant can either choose the most attractive customer to add (exploitation) or randomly pick one out of the k customers (exploration). This is referred to as the black transition rule

A red transition rule also exists, and allows red ants to exploit the most attractive black nodes and to explore better routes from other red nodes, as explained in more detail below. In each iteration, for some shipments that are labelled as red (meaning they are outsourced to a common carrier), the RB-ACS uses the red transition rule to determine cost-efficient fleet routes that are cheaper than direct LTL shipments. Once a cost-efficient fleet route is determined, the associated shipments are turned to black and will follow the black transition rule to be routed in the next iteration. After the transition is made, the attractiveness on the corresponding paths is updated to provide guidance to the following iterations.

After the red and black transition rules are completed, the shipment of interest is either fleet shipped or outsourced as a direct LTL shipment. Subsequently thereto, the local heuristic procedures may be called to improve the closed loop routes. The first local heuristic procedure is again referred to as permutation, and for each closed loop route, a dynamic program is implemented to permute the customers in order to find the sequence of customers on the route that will optimize the route cost. The second local heuristic procedure is referred to as a mutation, and considers changing the nearby routes to increase the cost savings.

Because a typical exemplary FlO program will consider at most three fleet sizes (i.e., small, medium, or large), fleet size reduction is preferably performed just before the completion of each iteration. Before the fleet size reduction, all the routes are built with the largest available truck size, and the reduction operation is conducted for every solution generated in the iteration.

Finally, RB-ACS repeats the red and black transition rules, local heuristic improvements, and fleet type optimization, to half of the specified iterations and collects the optimal assignments for each shipment. The red and black transition rules and local heuristic improvements are repeated for the shipments over each fleet type for some predetermined number of iterations. The resulting output is the optimized closed loop routing results.

Additional details regarding exemplary FlO program functionality/operation are provided below. The FlO program operates with the many of the same parameters/variables used by the exemplary FrO program, which are summarized in Table 1 above. Additional parameters/variables associated with the FlO program are shown in the following Table 2.

TABLE 2
Additional parameters used by the FlO Program

| | | Descriptions |
|---|---|---|
| parameters | [symbol] | Probability of choosing red node j from the |
| | | current red node i |
| | Δ(i, j) | the updated closed loop route cost by adding arc |
| | | (i, j) to the current route |
| | ε | Constance red-black penalty parameter |
| | m(i, j) | total direct LTL cost after adding nodes i and j |
| | | to the current route |
| | V₀ | set of black customers in the current iteration |
| | V₁ | Set of red customers in the current iteration |
| | Sₘₐₓ | The maximum number of solutions in each |
| | | iteration |
| | sₖ | A closed loop route that is operated by fleet k |

In accordance with the black transition rules discussed above, at each node i, potential next moves are evaluated, and decisions are made according to probability distributions. Here, τᵢⱼ is the pheromone concentration on edge (i, j), which is equal to the amount of pheromone accumulated on the path between the current node i and a possible move j. The visibility value ηᵢⱼ is regarded as the short-term possibility to serve a customer j, which is expressed by: ηᵢⱼ=dᵢⱼ⁻¹, which is the inverse of the length of edge (i, j). The decision about which customer to serve next depends on the short-term visibility value ηᵢⱼ and the long-term pheromone value τᵢⱼ. The black transition rule is the transition rule in the FrO program denoted as Equation (1). If at any step a black ant decides to explore a new path (q>q₀), it selects the most attractive customer j to visit according to the probability distribution represented above as Equation (2), where α=β=1. The FlO program may employ the same local updating rule and global updating rule as the FrO program, which rules are indicated in above Equations (3) and (4), respectively.

An exemplary RB-ACS consists of two interchangeable pheromone trails. While the black ants follow their transition rules to find high-quality routes (black), red ants search the potential direct LTL deliveries (red) and try to find cost-efficient closed loop routes. At each customer i, the RB-ACS first determines whether i is labeled red or black. The colors of the customers depend on the color of the ants (routes). And, each customer i can shift its color once the color of a route changes. If i is labeled as black, then it will follow the black transition rules described. However, if i is labeled as red, then the red transition rules are started. This rule allows red ants to exploit the most attractive black nodes according to Equation (1) above and to explore better routes from other red nodes according to Equation (10) below.

$$= \{ \begin{matrix}{e}^{- \frac{{d}_{ij}}{{m}_{j}}} , & if Δ ( i , j ) < ɛ \cdot m ( i , j ) , j ∈ {V}_{1} \\ 0 , & \text{otherwise}\end{matrix} \qquad ( 10 )$$

Assume the red node i is the current stop and the red ant wants to pick the successor customer j. The RB-ACS creates a sample of U[0,1] distributed random variable and denotes the obtained value by \tilde{t}. When \tilde{t}≥t, then j from the black nodes is exploited by this ant. When \tilde{t}<t, then j is selected from the red nodes according to the following discrete distribution with the probability [symbol] given by Equation (10). The threshold value t is called the red black exploration rate. The constance red-black penalty parameter (ε) in Equation (10) may be set as, for example, 1.2 to allow a few expensive closed loop routes to exist for the local improvement heuristics.

The local updating rule for the red pheromone trails is then the same as Equation (3) above. After a single iteration is finished, a global updating rule is performed on the paths connected to the red node i∈V₁, which is given by:

$$\begin{matrix}= {red}^{} = \{ \begin{matrix}{e}^{- \frac{{d}_{ij}}{{m}_{j}}} , & if ( i , j ) ∈ \{ {L}_{global} \} , j ∈ {V}_{1} \\ {τ}_{0} , & \text{otherwise}\end{matrix} & ( 11 ) \\ = {red}^{} = {τ}_{0} & ( 12 )\end{matrix}$$

Therefore, after each single iteration, the red routes from the global best solution L_{global} are intensified and the other arcs that flow in and out are downgraded to their initial pheromone values.

The exemplary red-black ant search procedure is represented below.

FlO Program - Ant search procedure in a single iteration (Algorithm 3)

```
Result: an updated route: s = (0, i₁, i₂, ... , i, 0)
Input:
Current partial route (0, i₁, i₂, ... , i), candidate list for customer i: Λ(i);
While closed loop route (0, i₁, i₂, . . . , i, 0) feasible do
  q₀ = q₀ₛ;
  if Λ(i) = Ø then
    complete the current route s;
    break
  else
    * the ant decides to do exploration *
    if q > q₀ then
      if i ∈ V₁ then
      * decide whether to explore from the red customers or the black customers *
      if t ≤ \tilde{t} then
        explore j from the tabu list s.t. j ∈ V₁ and j ∈ Λ(i) by Equation (10);
        $pick j = {arg max}_{j ∈ Λ ( i ) , j ∈ {V}_{1}}$
      else
        explore j from the tabu list s.t. j ∈ V₀ and j ∈ Λ(i) by Equation (2);
      end
    else
      * exploitation - no matter which color i is labeled *
      Exploit j from the tabu list s.t. j ∈ Λ(i) by Equation (1);
    end
    add j after i to the current partial route;
    updated the node indices (i ← j) and form a new closed loop route s;
    update the route information - weight, time, distance, fleet costs, layover, tabu lists,
etc.
  end
end while
```

In a similar manner to the ant colony optimization (ACO) system applied by the FrO program, the RB-ACS of the FlO program may also adopt mutation and permutation heuristics to improve the algorithmic performance. The permutation procedure associated with the FlO program may be the same as described above with respect to the FrO program. In this case, the only difference is the input and the output—since the FlO program is concerned with closed loop routing, the current partial route is sₖ=(0, i₁, i₂, . . . , i, 0), which includes a backhaul arc to the origin. A feasibility check evaluates the efficacy of the backhaul arc. And the cost z(sₖ) considers the backhaul cost and varies by different fleet sizes. Similarly, the output considers the closed loop routing, which gives z(sₖ)←min{f(0,0), z(sₖ)}; (0, i₁′, . . . , iₙ′, i, 0).

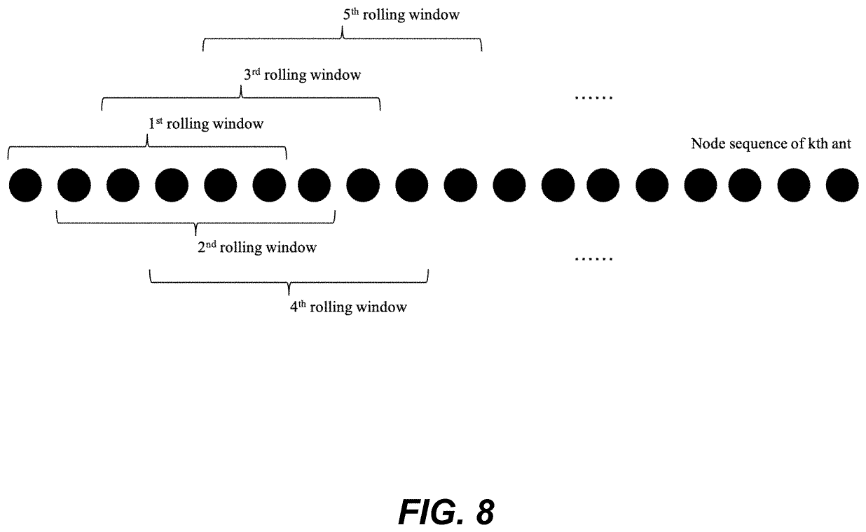

For long routes (typically more than 20 nodes), the FlO program preferably adopts a rolling-window to perform permutation, as represented in FIG. 8. The idea of this heuristic is to fix the length of the partial sequence (w) and roll w over the k^{th} route. For each w, the FlO program calls the DP (permutation) procedure described above and combines all the w's to form a new sequence. If the new sequence is feasible, it means the new sequence is better than the original sequence, and the FlO program assigns this solution to the k^{th} ant.

A completed solution (a colony) has been generated in a given iteration after all of the ants have finished their tours. The mutation heuristic can then be applied to help the RB-ACS reach better solutions in the search space by randomly mutating the routes and, hence, producing a new colony that is better but not very far from the original colony. In this operation, every ant is regarded as a black ant and the RB-ACS tries to improve the solution. The steps for the mutation heuristic in the RB-ACS may be the same as those described above with respect to the FrO program. The mutation and permutation probability at the iteration k is then defined in Equation (5) above.

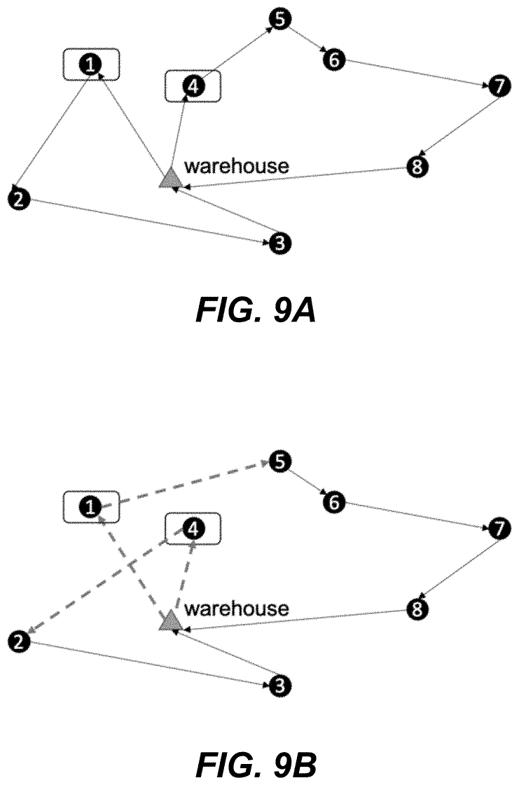

A diagrammatic representation of an exemplary mutation procedure relative to the FlO program is presented in FIGS. 9A-9B. FIG. 9A represents a generated closed loop route before application of the mutation procedure. FIG. 9B represents the closed loop route after application of the mutation procedure, where it can be observed that the 1st customer in the 1st route and the 4th customer in the 2nd route have been exchanged to improve the closed route cargo transportation solution.

A fleet size reduction is performed by the FlO program just before the completion of each iteration. Prior to the fleet size reduction, all of the closed loop routes are built with the largest available vehicle type, and the reduction operation is conducted for every solution generated in the iteration.

Next, the RB-ACS collects the iteration best solution z(A) and the global best solution z*(A). A fleet pheromone matrix is created to accumulate the fleet type assigned by these two solutions. For instance, given three types of available fleet types I₀, II₀, and III₀, shipment i can be allocated to II by z*(A) and is allocated to I by z(A) in k^{th} iteration. In this case, the matrix is added by 1 at the position of [i, I₀] and [i, II₀]. Moreover, in order to prevent ties, the algorithm chooses the iteration number N that cannot be divided by the number of available fleet types |V|.

After the specified iterations, the maximum counts over the rows of the matrix are the indicators of the optimized fleet sizes for the shipments. An exemplary fleet pheromone matrix is presented in Table 3 below. This exemplary matrix represents 50 iterations and 3 fleet types.

TABLE 3
Fleet size pheromone matrix

| Customers | Truck I₀ | Truck II₀ | Truck III₀ | Max Indicator |
|---|---|---|---|---|
| 1 | 50 | 0 | 0 | I₀ |
| 2 | 2 | 45 | 3 | II₀ |
| 3 | 39 | 11 | 0 | I₀ |
| 4 | 0 | 0 | 50 | III₀ |
| . . . | . . . | . . . | . . . | . . . |
| \|I\| | 3 | 5 | 42 | III₀ |

With the assigned fleet sizes, RB-ACS continues its iterations for IVI different clusters. Within each cluster, all of the shipments will be fulfilled by the same fleet type.

The main RB-ACS procedure contains 2N Iterations. While the first N Iterations are used to find the most appropriate fleet types for each shipment, the later N iterations are run separately for each fleet type for better convergence. The idea of running the search algorithms over each fleet type is inspired by the concept of Coordinate Descent and, therefore, each Fleet type here may be regarded as a coordinate direction. In addition, a few parallel processing efforts have been integrated into the exemplary RB-ACS. Specifically, the large shipment files are divided into pieces and multi-processed by independent origins and time periods.

The exemplary RB-ACS procedure may be represented as follows:

FIO Program - Red-black ant colony system procedure (Algorithm 4)

```
Result: z* (A); optimal closed loop routes and direct LTL assignments
Initialization:
Assign same amount of pheromone π₀ on each arc (i, j) ∈ A;
z* (A) ← Σ_{i∈I} mᵢ * initalize the network cost with the total direct LTL costs
for iteration = 1 → N do
  while solution ≤ Sₘₐₓ do
    * construct routes with the largest Fleet type for each solution *
    while i ∈ I not visited do
      call Algorithm 3 to build a complete route s;
      if length(s) ≥ 1 then
        call Algorithm 1;
      end
    end while
  call Algorithm 4 - mutation procedures between routes in this solution;
  fleet size reduction on each route s, update the cost and route information;
  reset the customers to unvisited, move to next solution;
  end while
  update z*(A), z(A) and the optimal closed loop routes and direct LTL assignments;
  label the black and red routes;
  call global updating rule by Equation (4) for black routes;
  call global updating rule by Equations (11) and (12) for red routes;
  update the fleet pheromone matrix for each shipment by z*(A), z(A);
end
divide the shipments into different clusters by their assigned fleet types V;
for size = 1 → |V| do
  for iteration = (N + 1) → 2N do
    Repeat: the same procedures for the first N iterations;
  end
  let z^{H} = z^{H} + z*_{size} (A) * store the new best cost z^{H};
end
Comparison:
if z^{H} ≤ z* (A) then
  z* (A) ← z^{H} ; * update the optimal results
End
```

As discussed above, the FlO program is operable to determine and output the lowest cost cargo transportation solution by comparing costs between closed-loop route shipments and direct LTL shipments. To that end, the FlO program may calculate the optimized cost for delivering each shipment by the following rule:

| Suppose route A is the route to be considered, then: | |
|---|---|
| if A is a close loop route (black): | |
| for i in route A: | |
| ${C}_{i} = \frac{1}{2} \cdot \frac{{w}_{i}}{{w}_{A}} \cdot [ {C}_{A} - ( \vert A \vert - 1 ) \cdot p ] + \frac{1}{2} \cdot \frac{{d}_{0 i}}{{d}_{0 A}} \cdot [ {C}_{A} - ( \vert A \vert - 1 ) \cdot p ] + p$ | (12) |
| else: | |
| for i in route A: | |
| Cᵢ = mᵢ | (13) |

This means, if route A is a fleet route, the cost for each shipment i on the route is calculated by Equation (12) above. However, if route A is not cost-efficient as a fleet route, each shipment i on the route is assigned to be a direct LTL shipment with the initial common carrier cost mᵢ, as reflected in Equation (13).

Pool Point Optimization (PPO)

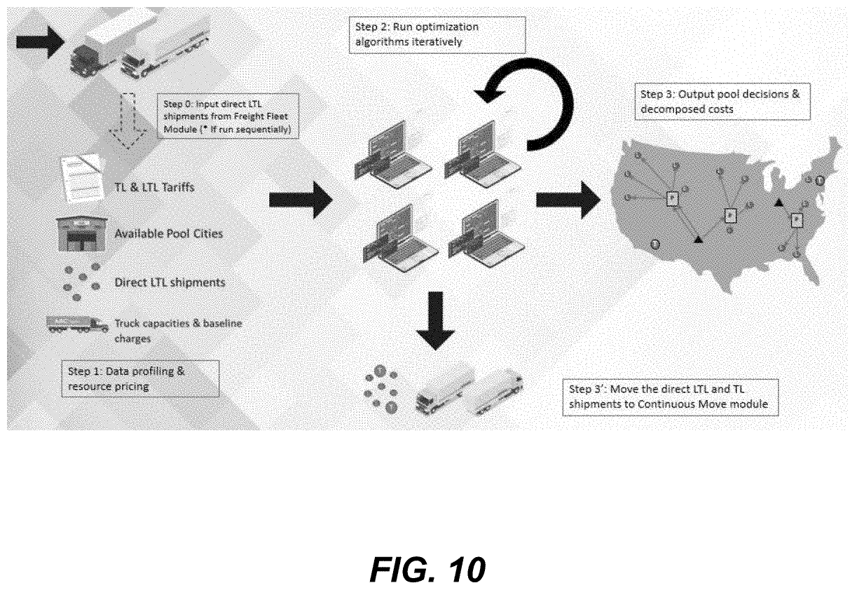

The pool point optimization (PPO) module is another possible program module of an exemplary system for developing optimized cargo transportation solutions, and is also the third module in the series of modules when an exemplary system utilizes multiple program modules operating sequentially. The PPO module is implemented as a computer program designed to run on a computer. The functionality of an exemplary PPO program is graphically illustrated in FIG. 10.

The PPO program is operable to identify near-optimal opportunities to use pool points (i.e., cross-dock locations that receive a consolidated TL sized shipment from a shipper and then organize the shipment into individual LTL shipments to the final destination) for a given set of shipments by evaluating the direct LTL shipment costs against costs from defined pooled lanes (i.e., a line haul that moves cargo from the origin to pool points).

The current process requires analysts to identify fixed pool regions before running any pool point decisions, where a fixed pool region is the pool point to which a shipment is routed, if the shipment is delivered in a specific geographical region. Then, a software tool is used to calculate the linehaul TL cost from the origins to the pre-selected pool points. Finally, the LTL costs from the pool points are added and it is determined if the pool points are less expensive than direct LTL shipping within the given time period.

The manual isolation of potential pool shipments based on geography according to the current, known, methodology downgrades the solution quality. In fact, the current, known, methodology does not account for the fact that shipments outside of the fixed pool regions could have also been shipped on the pool points and would make those pools viable.

To overcome the drawbacks associated with the currently employed process, the PPO program considers all available pool points and optimizes the assignments of pool points to each shipment by shipping date. The PPO program can be run independently or sequentially after the first two (FrO and FlO) modules in a sequential module system embodiment.

The required inputs may be obtained from shipment files that include, without limitation, the cargo ship date; origin and destination information; shipping weight; LTL shipment class; common carrier rating for direct LTL moves; a static list of cities for pool network locations; zip-5 (pool point) to zip-3 (destination) LTL tariff; and zip-3 (origin) to zip-5 (pool point) TL tariff.

The PPO program provides an iterative solution that assigns a shipment to the pool point when allocated TL pool linehaul cost plus pool LTL costs are less than the sum of direct LTL costs of the shipments on a given truck. In order to determine the TL pool linehaul cost, the PPO program may look up the TL tariff using zip codes. In order to determine the pool LTL costs, the PPO program may look up the LTL tariff using zip codes and weights. The LTL tariff is built on a baseline shipment class and the unit price is increased proportionally by the class change table.

The output of the PPO program may include at least the following information: (a) identification of which unrouted shipments would be pooled to which city and which others would have remained as direct LTL shipments; (b) a summary of which pool points and lanes are utilized in the model; and (c) allocated shipment level TL linehaul cost and the pool LTL cost.

For each shipping date, there may be multiple cost-efficient TL linehauls moving from the same origin to the same pool point. In such a situation, the PPO program will decide which shipment should be on which truck so that the total costs are minimized. Absent the PPO program, the current process would only consider savings for individual shipments and would fail to find near-optimal solutions.

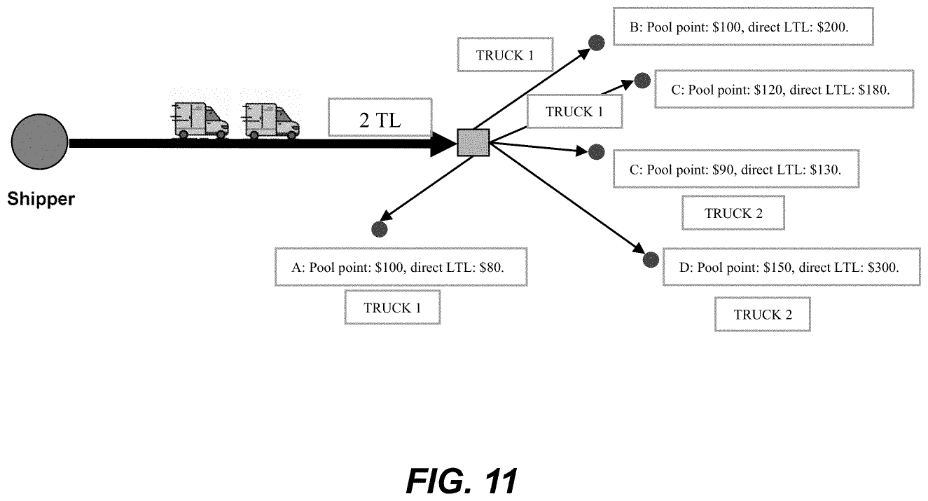

The aforementioned deficiency in the current process is illustrated in FIG. 11. As may be observed, when the PPO program is not used, shipment A will be assigned to direct LTL shipment because the pool point cost of $100 is greater than the direct LTL shipment cost of $80. In contrast, the PPO program recognizes that by consolidating shipments A, B, and C into a TL shipment and assigning said shipment to the pool point, the overall shipping cost is decreased by $140 (i.e., $80+$200+$180−$100−$100−$120). The PPO program may also be operable to determine on what truck the consolidated shipment should be placed.

The PPO program may be of a hybrid heuristic nature. The PPO program may also include two parts. The first part is a genetic procedure, which produces high-quality pool point decisions for the shipments; the second part being a local improvement heuristic procedure that considers all nearby feasible pool points for each shipment and tries to improve the assignments generated from the first, genetic procedure, part of the PPO program.

Broadly speaking, the PPO program simplifies and automates the costing scheme used in the current industrywide standard for pool point decision making. The PPO program includes guidance to continually improve the pool assignments.

With respect to the TL shipping costing, an exemplary PPO program may review the TL tariff, and look up the 3-digit zip code of a shipment origin and the 5-digit zip code of the pool point to determine the corresponding TL transportation cost. A TL fuel surcharge may be added to the determined TL transportation cost to obtain the final linehaul cost from the origin to the pool point.

With respect to the LTL shipping costing, an exemplary PPO program may review the LTL tariff and class change table, and determine the baseline unit price from the LTL tariff according to the 5-digit zip code of the pool point and the 3-digit zip code of the destination. The PPO program then multiplies the unit price with the weights of the shipments and a percentage based upon the classification of the products in the shipment. After calculating the LTL shipment cost, a discount from the common carrier may be applied.

The costing functionality of an exemplary PPO program may be represented as follows:

PPO Program-Costing Functions (Algorithm 5)

```
Input: shipment information - locations, assigned pool points, weights, shipment
class
function LTLCost(i)
Step 1:
  Given the 6 steps of weight (lbs) in the LTL tariff - [500, 1000, 2000, 5000,
10000, 20000], find the min value x* that is greater or equal to weight(i) and the
max value y* that is less than weight(i);
Step 2:
  cost = min{weight(i) * unit price(x*), y* * unit price(y*)};
Step 3:
  compare the cost with the baseline cost;
  LTL cost(i) = max{cost * class change multiplier * discount, min charge};
return LTL cost(i)
function TLCost(origin, pool point)
TL Cost = Linehaul cost + mileage * TL fuel surcharge percentage;
* this function calculates the allocated TL cost and LTL cost for each shipment*
Input a solution z;
function cost_for_shipment(z)
for i un I:
  if i is assigned to a pool point then
    cost for i = direct LTL cost for i;
  else
    cost for i = LTLCost(i)* (1+ LTL surcharge percent);
  end
* add the allocated linehaul TL cost to the shipment i *
for k in pool point list:
  if weight assigned to k ≠ 0 then
    get the number of trucks needed from origin to k;
    allocated TL cose f or i = TL Cost(origin, pool point) *
$number of trucks * \frac{weight ( i )}{weigh assigned to k} ;$
    label the truck ID for each shipment;
  end
if i is assigned to a pool point then
  cost for i+= allocated TL cost for i;
end
return cost for i
```

The genetic procedure used in the first part of the PPO program is a probabilistic search, which imitates the process of natural selection and evolution to evolve a population of initial solutions. A solution stands for a complete choice of the pool points. For instance, solution A=[Columbus: 1, Boston: 0], which means the pool point named Columbus is chosen (with value 1) and the pool point named Boston is not chosen (with value 0). An exemplary genetic procedure may be represented as follows:

PPO Program - Genetic procedure (Algorithm 6)

```
Inputs: shipment files, zip-to-zip distance matrix
Step 1:
  Set parameters - number of generations N, number of solutions in each
generation M;
  number of parents P, number of pool points K;
Step 2:
  for m in M:
    initialize the select or not select decisions (1,0) for the 50 pool points
in solution m;
Step 3: (crossover)
  for m in [P, M]:
    exchange the pool point decisions between the parents randomly;
    store the offspring solutions;
Step 4: (mutation)
  $for m in [ \frac{M}{2} + 1 , M ] \text{:}$
    for k in K:
      switch the value of 0 and 1 on pool point k to its opposite;
Step 5: (score and sort)
  call Algorithm 5 to get the cost for the M solutions;
  sort the M solutions by their objective function values;
Step 6:
  Repeat Steps 3-5 until the Nth generation.
```

Each solution provided by the PPO program is preferably treated as an individual, whose score is defined by a corresponding objective function value (transportation cost) and an infinity penalization to the decisions of choosing a pool without assigning any shipment thereto. In order to get the objective function value for a solution, each shipment may be assigned to its closest chosen pool point in the solution and the cost for such assignments is evaluated. Pairs of individuals of a given population are selected to act as parents and reproduce to generate the next population of better individuals through a structured yet randomized information exchange known as the crossover operator. Diversity may be added to the population by randomly changing some genes (e.g., choosing and canceling certain pool points). As new “offspring” are generated, unfit individuals in the population are replaced using the concept of survival of the fittest. This evaluation—selection—reproduction cycle is repeated until a pre-specified number of iterations is completed.

With the solution and detailed pool point assignments in place, the local improvement heuristic is called by the second part of the PPO program to further improve and optimize the solution. In this regard, consider an exemplary implementation of the PPO program in the U.S. that includes 50 available pool points across the country. In this example, the PPO program considers the closest 10 of the 50 pool points for each shipment to complete a reassignment. Then, the PPO program reassigns shipments based on the local improvement heuristic. After application of the local improvement heuristic, a near-optimal, reliable solution is generated. An exemplary local improvement heuristic may be represented as follows:

PPO Program - Local improvement heuristic (Algorithm 7)

```
Step 1:
  Make all shift and swap movements that improve the solution. Let the final cost be
C_{old}. Make this solution the current one.
Step 2:
  For each customer, calculate the cost C_{new} of shifting it from the current assigned pool
point to each of the 10 selected points in the solution.
Step 3:
  Determine the difference d = C_{new} − C_{old}.
Step 4:
  if d ≤ 0 then
    new assignment of the pool point is accepted.
  end if
  Go to Step 6.
Step 5:
  if d > 0 then
    $determine the probability of the new assignment being \text{accepted:} p = {e}^{- \frac{d}{t}} ,$
    where t is the temperature control parameter.
    * To accomplish this, generate a U[0,1] distributed random number r; if r ≤ p,
      assignment is accepted and made current, i.e., C_{new} and the current solution are
      both updated accordingly; otherwise (r > p), keep the current assignment.
Step 6:
  Repeat Steps 2-5 until all shipments have been evaluated.
```

Finally, the allocated cost for each shipment is calculated and the summary output is presented (e.g., as a printed Excel worksheet). Since there are an exponential number of combinations of pool point decisions, the PPO program may take a while to determine an efficient solution. To hasten solution determination, large shipment files may be divided into groups and multi-processed by origins and time periods.

In light of the foregoing description, an exemplary PPO program may be represented as follows:

Main PPO Program

```
while i ≤ number of iterations:
  call Algorithm 6;
  collect the best solution z^{H} generated from Algorithm 6;
  assign C_{old} = z^{H} and call Algorithm 7;
  call Algorithm 5 - cost_for_shipment( ) to get the allocated cost for
each shipment;
  i+= 1;
end while.
```

Round Trip Optimization (RTO)

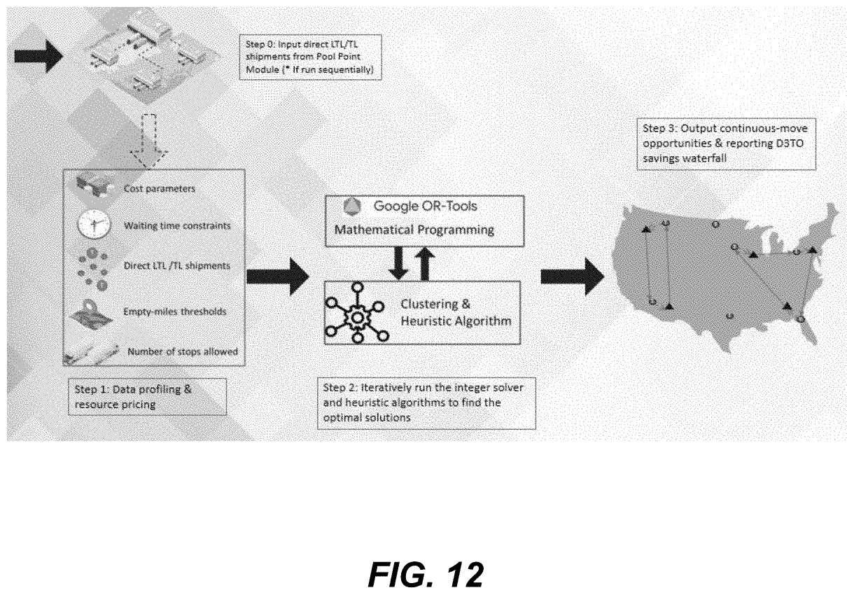

The round trip optimization (RTO) module is another possible program module of an exemplary system for developing optimized cargo transportation solutions, and is also the fourth and last module in the series of modules when an exemplary system utilizes multiple program modules operating sequentially. The RTO module is implemented as a computer program designed to run on a computer. The general functionality of an exemplary RTO program is graphically illustrated in FIG. 12.

An exemplary RTO program may consider parameters such as, but without limitation, maximum number of stops on the round trip; maximum waiting days before the next TL trip; maximum empty miles between stops; mileage cost and stop cost charged by the carrier; fixed carrier cost per day; cost spent on each layover; and whether or not to optimize by week.

The RTO program is operable to generate cost saving opportunities for cross-regional TL moves. In essence, the RTO program is directed to matching shipments in the geographical area of origins, and shipments in the geographical area of destinations, based on a variable defined by empty miles and transit dates.

The RTO program provides the highest level of optimization according to an exemplary system for optimized cargo transportation solution development, because the program can no longer improve the efficiency of LTL truckloads remaining at this point when the algorithms are run sequentially. That is, if an exemplary system includes the aforementioned FrO, FlO and PPO modules (programs) operating sequentially, most of the remaining unrouted shipments processed by the RTO program will be TL deliveries to long distance destinations.

When a truck makes a delivery to a destination, picks up cargo, and takes it back to the origin (a process referred to as a round trip move), the managed transportation provider can procure transportation at a lower rate. Prices especially decrease if a round trip move occurs at least once per week. When the round trip frequency is greater than or equal to, for example, once per day, a dedicated fleet may be proposed to add capacity and further lower the transportation costs. During the transportation solution design process, it is difficult to analyze multiple round trip moves where a route can have more than two pick-up and delivery regions because it is difficult to ensure consistent volume that meets the service levels. To solve this issue, one exemplary RTO program considers at most three stops for the assigned fleet or carrier in building the round trip routes.

The current manual solution design process relating to round trip moves includes the following five steps: (1) grouping shipments into lanes by region; (2) sorting and filtering lanes greater than 50 per year/annualized; (3) copying lanes to a new worksheet; (4) re-filtering origin region by top destination region and destination by top origin region; and (5) simulating shipments of round trip matches by week/date/transit. This manual process does not represent the full opportunity of round trip moves as it does not look across regions, and it typically takes three to five days to process.

Also when employing the current method, a solutions designer will decide whether to bid for round trips from carriers or to convert routes to a dedicated fleet based on the seasonality and round trip lane volume. Part of the analysis also includes comparing cost and service levels between a dedicated fleet and carriers completing round trips. An industry assumption is that round trip moves by a dedicated fleet reduces transportation costs by approximately 5% and provides guaranteed capacity.

An exemplary RTO program addresses the deficiencies in the current process by considering inter-regional TL moves. Also, the speed of the procedures used in the RTO program have been shown to save two to four days per transportation solution development project. Further, executing the RTO program as the last program in a sequence of programs optimizes the output from the RTO program, which can lead to significant cost savings.

An exemplary RTO program may be of a hybrid heuristic nature, and may combine two subcomponents—clustering and math programming. The exemplary RTO program solves the clustering and math programming subcomponents iteratively, and finds near-optimal cross-region TL round trips for multiple (e.g., up to three) deliveries. The RTO program may operate on only a weekly basis—i.e., the RTO program may only consider shipments that are shipped within the same week. At least one purpose for such a constraint would be that a truck cannot wait for an entire weekend before picking up the next shipment of the round trip.

In a first step, the exemplary RTO program clusters the shipments by origins and groups the shipments sharing the same origin and destination. In a second step, the RTO program runs a solver, such as but without limitation, a Google OR-Tools solver, to solve a mixed integer linear programming model. The indices of the model are no longer individual shipments, but the shipment clusters generated in the first step. After solving the model, the exact round trip routes are picked from cross-region arcs.

The RTO program also considers real-world operational constraints. For example, if a truck moves from point A to point B and can potentially carry a TL delivery from point C to point D, where point C is close to point B and point D is close to point A, then the route is called a round trip. The distance between point B and point C and the distance between point A and point D is referred to as empty miles. The RTO program preferably includes a maximum allowed empty mileage constraint for a feasible round trip. Also, the mileage costs for the TL moves and the empty mile moves are different. When the truck finishes the first delivery at point B, it needs to check the shipping date at point C. If the shipping date minus the arrival date of the truck to C is greater than the maximum allowed waiting days, then the round trip is infeasible. Such waiting time is regarded as a layover and the cost of the layover is charged by the amount of layover days. For each delivery, a stop cost will be charged and the truck will be charged by the fixed cost of the truck based on the days the truck is on the road. The logics and constraints of the round trip can be extended to some maximum number of stops (e.g., 3 stops). After the final delivery, the truck will return to the origin.

Additional details regarding RTO program functionality/operation are provided below, with the various parameters/variables used by an exemplary RTO program first summarized in the following Table 4.

TABLE 4
Parameters used by the RTO program

| Parameters | Descriptions |
|---|---|
| α | cost per mile for continous move rouse |
| cᵢⱼ | common carrier cost between i, j |
| L | max number of shipments limit |
| xᵢⱼ^{k} | $= \{ \begin{matrix}1 , & use round trip truck k between location i , j \\ 0 , & \text{otherwise}\end{matrix}$ |
| yᵢⱼ | $= \{ \begin{matrix}1 , & use direct TL \text{/} LTL between location i , j \\ 0 , & \text{otherwise}\end{matrix}$ |

The RTO program may also utilize, without limitation, the constraints, and the formulated functions, appearing in the following Table 5.

TABLE 5
Model [symbol]
Objective Function

| | |
|---|---|
| Minimize (common carrier cost + | Min Σ_{i∈I}Σ_{j∈I}Σ_{k∈V}(a · dᵢⱼ)xᵢⱼ^{k} + |
| continuous move cost) | Σ_{i∈I}Σ_{j∈I}cᵢⱼ · yᵢⱼ, i ≠ j |

Constraints

| | |
|---|---|
| Customer served by exactly one | yᵢⱼ + Σ_{k∈V}xᵢⱼ^{k} = 1, ∀i ∈ I, ∀j ∈ I, i ≠ j |
| vehicle | |
| Continuous moves always form | Σ_{j∈I}xᵢⱼ^{k} = Σ_{h∈I}xₕᵢ^{k}, ∀i ∈ I, ∀k ∈ V, |
| a loop | i ≠ j, i ≠ h |
| Max number of shipments limit | Σ_{i∈I}Σ_{j∈I}xᵢⱼ^{k} ≤ L, ∀k ∈ V, i ≠ j |
| Symmetry breaking inequality | Σ_{i∈I}Σ_{j∈I}xᵢⱼ^{k} ≥ Σ_{i∈I}Σ_{j∈I}xᵢⱼ^{k+1}, ∀k ∈ V |

An exemplary RTO program may be represented as follows:

RTO Program

```
Input: weekly shipment file, constraint parameters, costs
Step 1:
  Divide the shipment file into M sets by week;
Step 2:
  Cluster the shipments by origins for each of the M sets;
  Consolidate shipments that share the same origin and destination;
Step 3:
  Optimize model [symbol]  with Google OR Tool solver;
Step 4:
  Repeat steps 2-3 until the specified iterations;
Step 5:
  Collect the solution from the solver, find the round trip arcs if xᵢⱼ^{k} = 1;
Output: round trips & direct TL/LTL shipments.
```

The output of the RTO program may include two levels of information. For the round trip level, the RTO program may report, for example, actual delivery time, allocated cost for each TL trip, empty miles percentage, total distance of the round trip, total transit days, savings percentage, carried weight, etc. For the shipment level, the RTO program may report, for example, detailed shipment information, delivery sequences, round trip IDs, allocated savings, etc.

Exemplary system embodiments may be developed using different programming languages, including but not necessarily limited to, the Python™ open source programming language. Additional data organization functionality may be incorporated into an exemplary system, such as to process data input tables and to receive output results. Such data organization functionality may be developed, or an existing software application such as Microsoft Excel® may be used for this purpose. Exemplary transportation solutions modeled using the RTO module of an exemplary system may be optimized using various solvers. For example, and without limitation, Google OR-Tool solvers may be imported to support the functionalities of the RTO module.

An exemplary system for developing optimized cargo transportation solutions may be implemented on various computer systems, such as but not limited to, personal computers, networked personal computers, laptop computers, mini computers, mainframe computers, and distributed cloud computing environments. Such computer systems may be multiprocessor systems. One or more databases may be local to the computer system used and/or the computer system may be in communication with one or more remote databases. The database(s) may contain data such as data from the shipment files of a party for whom a transportation solution is being developed. Such computer systems may also include a variety of I/O devices for allowing an operator to interact with the system and for presenting information to the user and/or for implementing an optimized cargo transportation solution. Likewise, an exemplary computer system on which an exemplary optimized cargo transportation solution is implemented may communicate with one or more networks, such as the Internet, a wide area network (WAN) and/or a local area network (LAN).

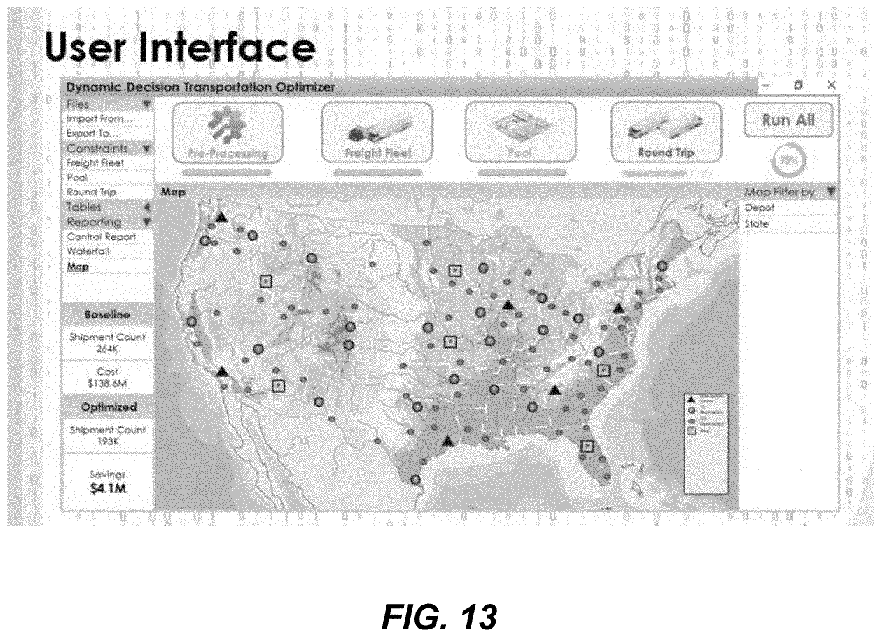

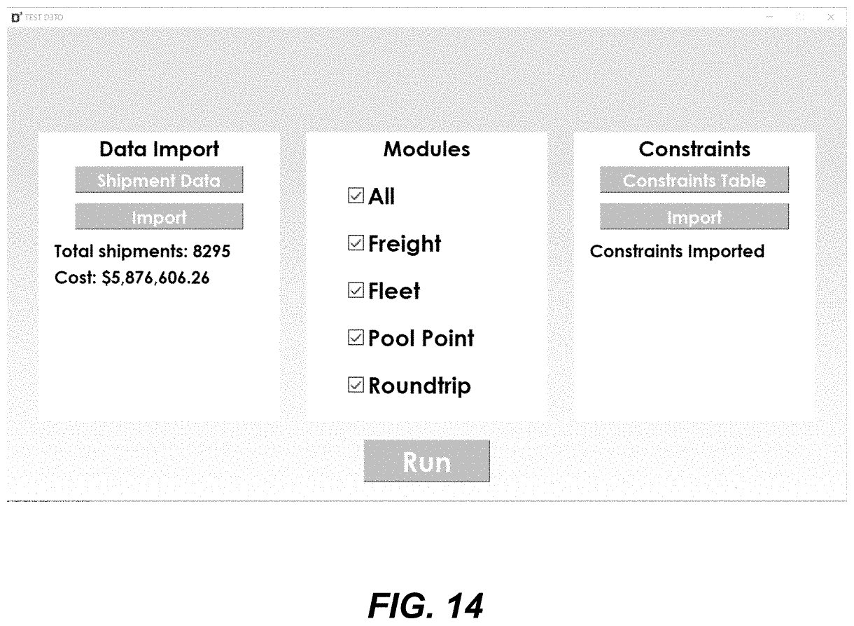

One exemplary user interface is represented in FIGS. 13-14. An exemplary user interface may allow for user customization. Data and constraints may be imported by a given user or may be manually inputted. After the data and constraints fields are filled the user may run any of the present system modules together or separately, as indicated.

While certain embodiments of the inventive concept are described in detail above, the scope of the inventive concept is not considered limited by such disclosure, and modifications are possible without departing from the spirit of the inventive concept as evidenced by the following claims:

What is claimed is:

1. A computerized method for developing an optimized cargo transportation solution, the method comprising:
inputting shipment file data associated with the entity for whom an optimized cargo transportation solution is being developed;
executing a freight optimization program that determines optimized one-way multi-stop routing and optimized closed-loop routing for the cargo and the costs associated therewith, and compares the one-way multi-stop route costs and/or closed-loop route costs with direct LTL route costs;
responsive to executing the freight optimization program, optionally executing a fleet optimization program that receives unrouted cargo shipment data as input from the freight optimization program, determines the near-optimal routing of direct LTL shipments, and compares the near-optimal direct LTL shipment cost with the cost of closed-loop route shipment using a dedicated truck fleet, so as to minimize the transportation cost;
responsive to executing the fleet optimization program, optionally executing a pool point optimization program that receives direct LTL shipment data as input from the fleet optimization program, and determines and outputs optimized pool decisions and decomposed costs;
responsive to executing the pool point optimization program, optionally executing a continuous move optimization program that receives direct LTL/TL shipment data as input from the pool point optimization program, and determines the optimal cargo transportation solutions; and
outputting an optimized cargo transportation solution.

2. The method of claim 1, wherein the shipment file data includes some or all of the information selected from the group consisting of distinct shipment ID; week; origin location, including any or all of origin city, state, zip-code, latitude and longitude; destination location, including any or all of destination city, state, zip-code, latitude and longitude; shipment units; shipment weights; shipment volumes; miles to origin destination; shipping date; delivery date; shipment class; original transportation mode; rated common carrier cost; information as to whether or not the shipment is required to be routed on a dedicated fleet.

3. The method of claim 1, wherein the freight optimization program considers some or all of the parameters selected from the group consisting of maximum number of stops; maximum number of layovers; maximum driving and working hours per day; minimum unloading time (in, e.g., hours); maximum allowed distance between stops; weight and volume capacities of the freight; average speed of the freight (in, e.g., mph); cost charged for a stop on a one-way multi-stop route; delivery time window; unloading speed (in, e.g., units/hour); route interval, including any or all of minimum and maximum distance to origin; and zip-code to zip-code unit rate matrix charged by the shipper (in, e.g., $/mile).

4. The method of claim 1, wherein the freight optimization program further considers freight optimization parameters selected from the group consisting of time constraints; capacity constraints; basic cost parameters; the tariff used to rate the zip-to-zip travel cost; and combinations thereof.

5. The method of claim 1, wherein the freight optimization program employs an ant colony optimization procedure to simultaneously optimize routing and cost comparisons.

6. The method of claim 1, wherein the freight optimization program operates iteratively, and when executed:
(a) divides a created one-way route into individual shipments;
(b) updates the cost of the individual shipments by the associated direct LTL shipping cost;
(c) generates multiple solutions in each iteration in order to select the solution with the lowest cost before moving to the next iteration; and
(d) repeats operations (a)-(c) above iteratively for some pre-specified number of iterations prior to outputting the lowest cost solution in the form of the best route assignments for the shipments.

7. The method of claim 1 wherein, when executed, the fleet optimization program considers some or all of the parameters selected from the group consisting of maximum number of stops; maximum number of layovers; maximum driving and working hours per day; minimum unloading time (in, e.g., hours); maximum allowed distance between stops; weight and volume capacities of the freight; average speed of the freight (in, e.g., mph); cost charged for a stop on a one-way multi-stop route; delivery time window; unloading speed (in, e.g., units/hour); route interval, including any or all of minimum and maximum distance to origin; and zip-code to zip-code unit rate matrix charged by the shipper (in, e.g., $/mile).

8. The method of claim 1 wherein, when executed, the fleet optimization program performs closed loop LTL shipment routing and cost estimation functions simultaneously using a metaheuristic technique.

9. The method of claim 8, wherein the fleet optimization program employs Red-Black Ant Colony System (RB-ACS) optimization functionality, where black ants are associated with the use of fleets to perform closed loop routing, and red ants are associated with shipments that should be shipped by direct LTL method.

10. The method of claim 9, wherein RB-ACS functionality is an iterative heuristic procedure comprising:
red and black ant transition rules;
local heuristic improvements;
fleet type optimization; and
iterative runs over different fleet types.

11. The method of claim 1 wherein, when executed, the pool point optimization program considers some or all of the parameters selected from the group consisting of the cargo ship date; cargo origin; cargo destination; shipping weight; LTL shipment class; common carrier rating for direct LTL moves; a static list of cities for pool network locations; zip-5 (pool point) to zip-3 (destination) LTL tariff; and zip-3 (origin) to zip-5 (pool point) TL tariff.

12. The method of claim 1 wherein, when executed, the pool point optimization program considers all available pool points, and optimizes the assignments of pool points to each shipment by shipping date.

13. The method of claim 1 wherein, when executed, the pool point optimization program is operative to:
identify near-optimal opportunities to use pool points for a given set of shipments by evaluating the direct LTL shipment costs against costs from defined pooled lanes;
where a pool point is defined as a cross-dock location that receives a consolidated TL sized shipment from a shipper and then organizes the shipment into individual LTL shipments to a final destination; and
where a defined pool lane is defined as a line haul that moves cargo from the origin to a pool point.

14. The method of claim 1 wherein, when executed, the output of the pool point optimization program includes at least:
identification of which unrouted shipments would be pooled to which city and which others would have remained as direct LTL shipments;
a summary of which pool points and lanes are utilized in the model; and
allocated shipment level TL linehaul cost and the pool LTL cost.

15. The method of claim 1 wherein, when executed, the round trip optimization program considers some or all of the parameters selected from the group consisting of maximum number of stops on the round trip; maximum waiting days before the next TL trip; maximum empty miles between stops; mileage cost and stop cost charged by the carrier; fixed carrier cost per day; cost spent on each layover; and whether or not to optimize by week.

16. The method of claim 1 wherein, when executed, the round trip optimization program matches shipments in the geographical area of origins, and shipments in the geographical area of destinations, based on a variable defined by empty miles and transit dates.

17. The method of claim 1, wherein the round trip optimization program:
includes a clustering subcomponent that clusters shipments by origins and groups shipments sharing the same origin and destination;
combines the clustering subcomponent with a math programming subcomponent;
solves the clustering and math programming subcomponents iteratively; and
determines near-optimal cross-region TL round trips for multiple deliveries.

18. The method of claim 1 wherein, when executed, the output of the round trip optimization program includes at least:
round trip level information comprising one or more of actual delivery time, allocated cost for each TL trip, empty miles percentage, total distance of the round trip, total transit days, savings percentage, and carried weight; and
shipment level information comprising one or more of detailed shipment information, delivery sequences, round trip IDs, and allocated cost savings.

19. A computerized multi-step method for developing an optimized cargo transportation solution, the method comprising:
inputting shipment file data associated with the entity for whom an optimized cargo transportation solution is being developed;
(a) executing a freight optimization program, the freight optimization program being iterative in nature and when executed:
(i) dividing a created one-way route into individual shipments,
(ii) updating the cost of the individual shipments by the associated direct LTL shipping cost,
(iii) generating multiple solutions in each iteration in order to select the solution with the lowest cost before moving to the next iteration,
(iv) repeating operations (i)-(iv) above iteratively for some pre-specified number of iterations prior to outputting the lowest cost solution in the form of the best route assignments for the shipments, and
employing an ant colony optimization procedure to simultaneously optimize routing and cost comparisons;
(b) responsive to executing the freight optimization program, executing a fleet optimization program that receives unrouted cargo shipment data as input from the freight optimization program and operates to:
determine the near-optimal routing of direct LTL shipments,
compare the near-optimal direct LTL shipment cost with the cost of closed-loop route shipment using a dedicated truck fleet to minimize the transportation cost, and
employ Red-Black Ant Colony System (RB-ACS) optimization functionality;
(c) responsive to executing the fleet optimization program, executing a pool point optimization program that receives direct LTL shipment data as input from the fleet optimization program and operates to:
determine optimized pool decisions by identifying near-optimal opportunities to use pool points for a given set of shipments by evaluating the direct LTL shipment costs against costs from defined pooled lanes, where a pool point is defined as a cross-dock location that receives a consolidated TL sized shipment from a shipper and then organizes the shipment into individual LTL shipments to a final destination, and where a defined pool lane is a line haul that moves cargo from the origin to a pool point; and
output optimized pool decisions and decomposed costs;
(d) responsive to executing the pool point optimization program, executing a continuous move optimization program that receives direct LTL/TL shipment data as input from the pool point optimization program and operates to:
determine the optimized cargo transportation solutions in part by matching shipments in the geographical area of origins, and shipments in the geographical area of destinations, based on a variable defined by empty miles and transit dates; and
output an optimized cargo transportation solution including information selected from the group consisting of optimized routing details, associated cost savings, and a shipping schedule.

20. The method of claim 19, wherein the output of the pool point optimization program includes at least:
identification of which unrouted shipments would be pooled to which city and which others would have remained as direct LTL shipments;
a summary of which pool points and lanes are utilized in the model; and
allocated shipment level TL linehaul cost and the pool LTL cost.

21. The method of claim 19, wherein the output of the round trip optimization program further includes:
round trip level information comprising one or more of actual delivery time, allocated cost for each TL trip, empty miles percentage, total distance of the round trip, total transit days, savings percentage, and carried weight; and
shipment level information comprising one or more of detailed shipment information, delivery sequences, round trip IDs, and allocated cost savings.

22. A computerized system for developing an optimized cargo transportation solution, comprising:
a cargo transportation optimization software application including:
a freight optimization program,
a fleet optimization program,
a pool point optimization program, and
a round trip optimization program;
a computer hosting the cargo transportation optimization software application;
shipment file data as input to the cargo transportation optimization software application, the shipment file data resident on the computer or accessible by the computer;
instructions within the cargo transportation optimization software application that when executed configure the computer to:
execute the freight optimization program to determine optimized one-way multi-stop routing and optimized closed-loop routing for the cargo and the costs associated therewith, and to compare the one-way multi-stop route costs and/or closed-loop route costs with direct LTL route costs;
subsequent to executing the freight optimization program, input unrouted cargo shipment data from the freight optimization program into to the fleet optimization program, and execute the fleet optimization program to determine near-optimal routing of direct LTL shipments and to compare the near-optimal direct LTL shipment cost with the cost of closed-loop route shipment using a dedicated truck fleet, so as to minimize the transportation cost;
subsequent to executing the fleet optimization program, input direct LTL shipment data from the fleet optimization program into the pool point optimization program, and execute the pool point optimization program to determine and output optimized pool decisions and decomposed costs;
subsequent to executing the pool point optimization program, input direct LTL/TL shipment data to the continuous move optimization program, and execute the continuous move optimization program to determine optimized cargo transportation solutions; and
output an optimized cargo transportation solution including information selected from the group consisting of optimized routing details, associated cost savings, and a shipping schedule.
